(19) United States
(12) Patent Application Publication
(10) Pub. No.: US 2024/0305509 A1
(43) Pub. Date: Sep. 12, 2024

(54) Soft detection of integer-combination of multiple data streams

(71) Applicant: BEIHANG UNIVERSITY, Beijing (CN)

(72) Inventors: Tao Yang, Beijing (CN); Xinzhe Qiu, Beijing (CN); Rongke Liu, Beijing (CN)

(21) Appl. No.: 18/401,683

(22) Filed: Jan. 1, 2024

(30) Foreign Application Priority Data
Aug. 17, 2023 (CN) 202311037503.1

(51) Int. Cl. H04L 25/06; H04B 7/0452

(52) U.S. Cl. CPC H04L 25/067; H04B 7/0452

(57) ABSTRACT

A method and a system for soft decision detection of multiple data stream integer-combinations are described, belonging to a technical field of communication and information systems, information theory and coding, and signal and information processing. The method includes steps of: step 1: sending a signal; step 2: receiving the signal; step 3: defining the multiple data stream integer-combinations; and step 4: computing a posterior probability for the multiple data stream integer-combinations. The method of the present invention has low complexity, parallel processing architecture and low processing delay, so that the decoding performance is close to the capacity limit. The present invention is particularly suitable for cell-free networks to achieve better efficiency in the utilization of the air interface and the backhaul link.

### CROSS REFERENCE OF RELATED APPLICATION

The present invention claims priority under 35 U.S.C. 119(a-d) to CN 202311037503.1, filed Aug. 17, 2023.

### BACKGROUND OF THE PRESENT INVENTION

### Field of Invention

The present invention relates to a method and a system for soft decision detection of the integer-combinations of multiple data streams, belonging to a technical field of communication and information systems, information theory and coding, and signal and information processing.

### Description of Related Arts

A core problem in wireless communications is the efficient handling of interference, including but not limited to inter-user, inter-beam, inter-symbol, and inter-carrier interference. Conventional methods of treating interference are subject to significant performance loss or high implementation costs. For the multi-user uplink as an example, the optimal detection method is maximum likelihood (ML) rule. However, the complexity of ML detection is exponential to the number of data streams, which is not feasible to implement when the number of streams is large. Conventional linear filtering based processing methods, such as zero-forcing (ZF) and linear minimum mean square error (MMSE), suffer from significant performance loss (see [D. Tse and P. Viswanath, “Fundamentals of wireless communication,” Cambridge University Press, 2005.]). Iterative detection and decoding (IDD) can significantly improve the performance of linear detection, but it suffers from high complexity, high processing delay and high memory consumption due to iterative processing, as well as from convergence problems due to the mismatch between the detector and channel encoder and decoder (see [Q. Chen, F. Yu, T. Yang, and R. Liu, “Gaussian and fading multiple access using linear physical-layer network coding,” IEEE Trans. Wireless Comm., May, 2023.]). For the multiuser downlink, ZF and MMSE based precoding methods suffer from significant rate losses, while the schemes based on dirty paper coding suffer from high complexity and high latency due to serial processing at the transmitter.

It has been proved that lattice reduction (LR) detection and integer-forcing (IF) linear receiver enable more efficient treatment of interference (see [B. Nazer and M. Gastpar, “Compute-and-forward: Harnessing interference through structured codes,” IEEE Trans. Inf. Theory, vol. 57, no. 10, pp. 6463-6486, October 2011.] and [J. Zhan, B. Nazer, U. Erez, and M. Gastpar, “Integer-forcing linear receivers,” IEEE Trans. Inf. Theory, vol. 60, no. 12, pp. 7661-7685, December 2014.]). The core idea is to exploit the algebraic structure of lattice to perform efficient detection and decoding of the “integer-combinations (ICB) of multiple data streams”, instead of complete detection and decoding of each individual data stream. Compared with ZF and MMSE detection, LR and IF can realize “full diversity gain” and support “overload transmission” (the number of streams K is larger than the number of receiving antennas N). In LR and IF, the receiver does not require iterative detection, avoiding a series of practical issues of IDD. For the multi-user downlink, LR and IF based precoding can achieve a sum rate close to the channel capacity at low cost and low processing delay (see [D. Silva, G. Pivaro, G. Fraidenraich, and B. Aazhang, “On integer-forcing precoding for the Gaussian MIMO broadcast channel,” IEEE Tran. Wireless Comm., vol. 16, no. 7, pp. 4476-4488, 2017.]). Essentially, the LR and IF processing methods are based on the idea of solving ICBs of multiple data streams, following the notions of lattice codes, compute-forward (CF), and physical-layer network coding (PNC) of network information theory (see [B. Nazer and M. Gastpar, “Compute-and-forward: Harnessing interference through structured codes,” IEEE Trans. Inf. Theory, vol. 57, no. 10, pp. 6463-6486, October 2011.]).

As is widely known, channel coding is a core element in communication systems. It not only supports near-capacity spectral efficiency with satisfactory error-rate performance, but also maintains system stability and reliability. Mainstream channel coding techniques include low-density parity-check (LDPC) codes, polar codes, and their variants in the 5G NR standard. In particular, soft decision decoding is indispensable for achieving the near-capacity decoding, with several decibels (dB) of performance improvement over hard decision decoding (see [S. Lin and D. J. Costello, “Error control coding, 2nd edition,” Pearson, 2004.]).

Prior to the present invention, however, the computations of the ICBs of multiple data streams in LR, PNC, CF, and IF were all (or mostly) based on hard decision detection, and soft decision detection methods with high-performance and low-complexity were missing, resulting in a gap of at least several dBs from the performance limit, as well as poor reliability and stability. Therefore, there is an urgent need to provide a method for soft decision detection of the ICBs of multiple data streams, so as to accurately compute the a posteriori probability of the ICBs with an affordable complexity. This is required to realize the benefits of the PNC, CF, and IF concepts in practical uplink and downlink multi-user communications and cell-free networks.

Based on the above, for the inter-user, inter-beam, inter-symbol, and inter-carrier interference problems in wireless communications, the present invention provides efficient processing of interference by solving the ICBs of multiple data streams based on the idea of lattice, physical-layer network coding, or compute-forward. In particular, for the channel-coded data streams, the present invention proposes a method for soft decision detection of the ICB. This method accurately calculates the a posteriori probability of the multiple data stream integer-combinations, so that the decoding performance is close to the capacity limit, and the complexity is linearly related to the number of streams. Furthermore, based on this method, the present invention proposes two novel systems: a lattice-based downlink MIMO broadcasting system, and a lattice-based cell-free MIMO system, which provide significant improvements in functionality and performance.

### SUMMARY OF THE PRESENT INVENTION

An object of the present invention is to provide a method for soft decision detection of multiple data stream integer-combinations. This method accurately calculates the a posteriori probability (APP) of the ICBs, so that the decoding performance is close to the capacity limit. According to the method of the present invention, the complexity is linearly related to the number of data streams, and a parallel processing architecture provided which has low processing delay. The present invention realizes the advanced concepts of lattice coding, compute-forward, and physical-layer network coding of information theory and coding theory in practical communication systems, which can be used in lattice based high-efficiency multi-user detection, precoding, distributed base station processing with cell-free network, inter-carrier interference processing, and so on.

Another object of the present invention is to provide an application of the soft decision detection method in a lattice-code multiple-access (LCMA) system.

Another object of the present invention is to provide a lattice-based downlink MIMO broadcasting system applying the soft decision detection method, which can be used in flat channel as well as frequency-selective channel models to improve system functionality and performance.

Yet another object of the present invention is to provide a lattice-based cell-free MIMO system, which can be used for soft decision detection of ICB with better frame error rate (FER) performance.

Accordingly, the present invention provides a method for soft decision detection of ICBs of multiple data streams, comprising steps of:

step 1: sending a signal

considering K streams of messages, denoted by row vectors b₁^{T}, . . . , b_{K}^{T}; denoting the i-th data stream after channel-coding with a row vector cᵢ^{T}, i=1, 2, . . . , K, wherein the length of the coded data stream is n; denoting the t-th symbol position of cᵢ^{T} with cᵢ[t], t=1, . . . , n; and denoting the t-th symbol position of all the K data streams with a column vector c[t]=[c₁[t], . . . , c_{K}[t]]^{T};

considering 2^{m}-ary channel-coding, m=1, 2, . . . , then cᵢ[t]∈{0, . . . , 2^{m}−1}, where the elements of cᵢ[t] are nonnegative integers no greater than 2^{m}−1; mapping a sequence of channel-coded data streams symbol-by-symbol into a 2^{m}-PAM modulated signal sequence:

$${x}_{i}^{T} = \frac{1}{γ} ( {c}_{i}^{T} - \frac{{2}^{m} - 1}{2} ) ∈ \frac{1}{γ} {\{ \frac{1 - {2}^{m}}{2} , … , \frac{{2}^{m} - 1}{2} \}}^{n} , i = 1 , … , K , \qquad ( 1 )$$

wherein γ is a normalization factor ensuring the average energy of the sequence xᵢ^{T} is 1; elements of xᵢ^{T} are all integers divided by γ; all K streams of signals are transmitted simultaneously;

for a complex model, adopting two independent codes and modulations, and transmitting in both in-phase and quadrature parts to form 2^{m}-QAM modulation of I/Q, which is in line with the 2^{m}-PAM and 2^{m}-QAM modulations that are widely used in mainstream communication systems;

step 2: received signal

considering a spatial dimension of received signals at a receiver as N; (for example, the receiver is equipped with N antennas, each providing one observation; alternatively, the system has a spreading sequence length of N, with each code-slice signal providing one observation)

for a real-valued model, denoting the received signal as:

$$Y = {\sum }_{i = 1}^{K} \sqrt{ρ} {h}_{i} {x}_{i}^{T} + Z = \sqrt{ρ} HX + Z \qquad ( 2 )$$

wherein hᵢ denotes a channel vector of N observations from the i-th stream signal to the receiver; H=[h₁, . . . , h_{K}] denotes a channel matrix, containing the channel vectors corresponding to all stream signals; a matrix X=[x₁, . . . , x_{K}]^{T} denotes a sequence of all the K streams of signals, wherein the i-th row represents the i-th stream signal; Z denotes an additive white Gaussian noise (AWGN) matrix, whose elements are independently and identically distributed zero-mean unit-variance Gaussian noises; ρ denotes the average energy of the stream signals, which is equivalent to signal-to-noise ratio (SNR); Y=[y[1], . . . , y[n]], y[t] is a received signal vector for the t-th symbol position;

wherein a complex-valued model is represented by a real-valued model of doubled dimension:

$$[ \begin{matrix}{Y}^{R e} \\ {Y}^{I m}\end{matrix} ] = \sqrt{ρ} [ \begin{matrix}{H}^{R e} & - {H}^{I m} \\ {H}^{I m} & {H}^{R e}\end{matrix} ] [ \begin{matrix}{x}^{R e} \\ {x}^{I m}\end{matrix} ] + [ \begin{matrix}{z}^{R e} \\ {z}^{I m}\end{matrix} ] \qquad ( 3 )$$

for clarity of presentation, a real-valued model is described here;

step 3: defining the ICBs of multiple data streams

considering a not all zero integer coefficient vector a^{T}∈Z^{K} with length K; denoting an integer-combination (ICB) on Z₂_{^{m}} with respect to c[t] as:

$${a}^{T} ⊗ c [ t ] = mod ( {a}^{T} c [ t ] , {2}^{m} ) t = 1 , … , n \qquad ( 4 )$$

wherein mod (□, 2^{m}) means a mod 2^{m} operation, and a range of values of the ICB is a^{T}⊗c[t]∈{0, . . . , 2^{m}−1};

in general, L ICBs are denoted as:

$${a}_{l}^{T} ⊗ c [ t ] , l = 1 , … , L , t = 1 , … , n , \qquad ( 5 )$$

wherein aₗ^{T}∈Z^{K} denotes an integer coefficient vector corresponding to the l-th ICB;

the present invention is applicable to any coefficient vector a₁^{T}, . . . , a_{L}^{T}, and is not focused on selection of the optimal a₁^{T}, . . . , a_{L}^{T}; for the sake of completeness of the specification, a method for selecting the optimal a₁^{T}, . . . , a_{L}^{T} is briefly described in step 3 of embodiment 1; and

step 4: computing a posterior probability for the ICBs of multiple data streams (core algorithm of the present invention)

the receiver computes the L ICBs based on the received signal Y=[y[1], . . . , y[n]], which borrows ideas of lattice, PNC, and IF; for the channel-coded system, the present invention provides efficient algorithms for accurately solving the a posteriori probability of the L ICBs, which forms soft decision detection results of the ICBs;

because of a symbol-by-symbol operation, a symbol position index “[t]” can be omitted below; recalling the range of values of the ICB a^{T}⊗c[t]=θ,θ∈{0, . . . , 2^{m}−1}; and computing the posterior probability of the ICB as:

$$y \to p ( {a}_{l}^{T} ⊗ c = θ \vert y ) , θ ∈ \{ 0 , … , {2}^{m} - 1 \} , \qquad ( 6 )$$

wherein l=1, . . . , L;

for L integer coefficient vectors a₁^{T}, . . . , a_{L}^{T}, operating the equation (6) as follows:

a) linear filter

defining W as a linear filtering matrix with a size of L×N, which only contains real elements; defining wₗ^{T} as the l-th row of W and normalizing as ∥wₗ∥²=1; filtering to form L signals:

$$\begin{matrix}\text{?} = {w}_{l}^{T} y = \sqrt{ρ} {w}_{l}^{T} {{å}_{i = 1}}^{K} {h}_{i} {x}_{i} + \text{?} \\ = {{å}_{i = 1}}^{K} \sqrt{ρ} {ψ}_{l , i} {x}_{i} + \text{?} , l = 1 , L , L ,\end{matrix} \qquad ( 7 )$$

$$\text{?} \text{indicates text missing or illegible when filed}$$

wherein ψ_{l,i}=wₗ^{T}hᵢ is a real-valued equivalent gain, and the variance of a noise term \tilde{z}ₗ is 1;

b) signal representation

in order to calculate the posterior probability of aₗ^{T}⊗c, equivalently representing the received signals defined by the equation (7) as follows; using Iₗ□{i:a_{l,i}≠0} to collect positions of non-zero terms of aₗ, wherein Iₗ^{c} denotes a complement, and ω(aₗ)@|Iₗ| denotes a quantity of the non-zero terms of aₗ; then the equation (7) is expressed as:

$$\text{?} = {å}_{i \hat{I} {I}_{i}} \sqrt{ρ} {ψ}_{l , i} {x}_{i} + {å}_{i \hat{I} {I}_{i}^{c}} , \sqrt{ρ} {ψ}_{l , i} {x}_{i} + \text{?} = {å}_{i \hat{I} {I}_{i}} \sqrt{ρ} {ψ}_{l , i} {x}_{i} + {ξ}_{l} , ; \qquad ( 8 )$$

$$\text{?} \text{indicates text missing or illegible when filed}$$

wherein

$${\sum }_{i ∈ {I}_{i}} \sqrt{ρ} {ψ}_{l , i} {x}_{i}$$

denotes superposition of signals of ω(aₗ) users with non-zero coefficients of aₗ, which is a useful signal part for computation of the ICBs;

$${\sum }_{i ∈ {I}_{i}} \sqrt{ρ} {ψ}_{l , i} {x}_{i}$$

also contains signals of remaining K−ω(aₗ) users, which corresponds to zero coefficients of aₗ, and is not relevant to the ICBs;

$${ξ}_{l} = {\sum }_{i ∈ {I}_{i}^{c}} \sqrt{ρ} {ψ}_{l , i} {x}_{i} + {\tilde{z}}_{l}$$

is considered as equivalent noise, which is not relevant to the useful signal part; for a sufficiently large K, |Iₗ^{c}| is also sufficiently large; according to central limit theorem, the equivalent noise ξₗ follows a Gaussian distribution, with zero mean and variance

$${\tilde{σ}}_{l}^{2} = {γ}^{2} ( ρ {\sum }_{i ∈ {I}_{i}^{c}} {ψ}_{l , i}^{2} + 1 ) ;$$

using a bijection between xᵢ and cᵢ in the equation (1), which is

$${x}_{i} = \frac{1}{γ} ( {c}_{i} - \frac{{2}^{m} - 1}{2} ) ,$$

to further simplify the equation (8) as:

$$\text{?} \frac{\sqrt{ρ}}{γ} = {å}_{i \hat{I} {I}_{i}} {ψ}_{l , i} {c}_{i} + {ξ}_{l} - {φ}_{l} \qquad ( 9 )$$

$$\text{?} \text{indicates text missing or illegible when filed}$$

wherein

$${φ}_{l} = \frac{\sqrt{ρ}}{γ} \frac{{2}^{m} - 1}{2} {\sum }_{i ∈ {I}_{i}} {ψ}_{l , i}$$

is not relevant to the signals, which resembles a DC component and is intended to convert the signal from {−1, +1} to {0,1};

$${φ}_{l} = \frac{\sqrt{ρ}}{γ} \frac{{2}^{m} - 1}{2} {\sum }_{i ∈ {I}_{i}} {ψ}_{l , i}$$

is compensated by y̅ₗ=\tilde{y}ₗ+φₗ to obtain:

$${\overline{y}}_{l} = \frac{\sqrt{ρ}}{γ} {\sum }_{i ∈ {I}_{i}} {ψ}_{l , i} {c}_{i} + {ξ}_{l} \qquad ( 10 )$$

then, only signals of the users corresponding to non-zero elements in aₗ exist in a signal portion of the equation (1); and computation of the posterior probability of the ICBs is denoted as:

$${\overline{y}}_{l} \to p ( {a}_{l}^{T} ⊗ c = θ \vert {\overline{y}}_{l} ) , θ ∈ \{ 0 , … , {2}^{m} - 1 \} , \qquad ( 11 )$$

wherein l=1, . . . , L;

c) exact computation of a likelihood function for the ICBs

to find the posterior probability in the equation (11), the likelihood function p(y̅ₗ|aₗ^{T}⊗c=θ) is necessary, which is calculated as follows:

a vector āₗ contains only non-zero elements of aₗ and a vector c̅ contains only portions of c that corresponds to the non-zero elements of aₗ (the portion that belongs to Iₗ); lengths of āₗ and c̅ are ω(aₗ)=|Iₗ|; the total probability equation is:

$$p ( {\overline{y}}_{l} \vert {a}_{l}^{T} ⊗ c = θ ) = p ( {\overline{y}}_{l} \vert {\overline{a}}_{l}^{T} ⊗ \overline{c} = θ ) = {\sum }_{\overline{c} : {\overline{a}}_{l}^{T} ⊗ \overline{c} = θ} p ( {\overline{y}}_{𝕝} \vert \overline{c} ) p ( \overline{c} \vert {\overline{a}}_{l}^{T} ⊗ \overline{c} = θ ) \qquad ( 12 )$$

then the equation (10) is modified as:

$$p ( {\overline{y}}_{l} \vert \overline{c} ) = \frac{1}{\sqrt{2 π}} exp ( \frac{- {\vert {\overline{y}}_{l} - \frac{\sqrt{ρ}}{γ} {\sum }_{i ∈ {I}_{l}} {ψ}_{l , i} {c}_{i} \vert}^{2}}{2 {\tilde{σ}}_{l}^{2}} ) \qquad ( 13 )$$

if the likelihood function (12) is solved directly here, it is necessary to compute p(y̅ₗ|c̅) values of 2^{mω(a}^{ₗ}⁾ candidate c̅ vectors, and thus its complexity is of the order of O (2^{m|ω(a}^{ₗ}^{)|}); therefore, the present invention provides an efficient method for computing the likelihood function (12);

d) computation of a low-complexity likelihood function based on Gaussian approximation

considering a “many-to-one” mapping between āₗ^{T}c̅ and āₗ^{T}⊗c̅, a likelihood function p(y̅ₗ|āₗ^{T}⊗c̅=θ) for āₗ^{T}c̅ is computed first, which is then transformed into p(y̅ₗ|āₗ^{T}⊗c̅=θ);

using a set Ωₗ(θ̅)={c̅:āₗ^{T}c̅=θ̅} to collect candidate sequences of c̅ which satisfy āₗ^{T}c̅=θ̅; wherein for a given āₗ^{T}c̅=θ̅, the conditional mean of y̅ₗ is:

$${μ}_{l} ( \overline{θ} ) = {E}_{c} ( {\overline{y}}_{l} \vert {\overline{a}}_{l}^{T} c = \overline{θ} ) = {E}_{c} ( \frac{\sqrt{ρ}}{γ} {\sum }_{i ∈ {I}_{l}} {ψ}_{l , i} {c}_{i} + {ξ}_{l} \vert {\overline{a}}_{l}^{T} \overline{c} = \overline{θ} ) = \frac{1}{\vert {Ω}_{l} ( \overline{θ} ) \vert} {\sum }_{\overline{c} ∈ {Ω}_{l} ( \overline{θ} )} {\sum }_{i ∈ {I}_{l}} \frac{\sqrt{ρ}}{γ} {ψ}_{l , i} {c}_{i} \qquad ( 14 )$$

the conditional variance of y̅ₗ is:

$$\begin{matrix}{σ}_{l}^{2} ( \overline{θ} ) = {E}_{c} ( {\vert {\sum }_{i ∈ {I}_{l}} \frac{\sqrt{ρ}}{γ} {ψ}_{l , i} {c}_{i} + {ξ}_{l} - {μ}_{l} ( \overline{θ} ) \vert}^{2} ) \\ = {{E}_{c} ( {\sum }_{i ∈ {I}_{l}} \frac{\sqrt{ρ}}{γ} {ψ}_{l , i} {c}_{i} )}^{2} - {μ}_{l}^{2} ( \overline{θ} ) + {\tilde{σ}}_{l}^{2} \\ = \frac{1}{\vert {Ω}_{l} ( \overline{θ} ) \vert} {\sum }_{c ∈ {Ω}_{l} ( \overline{θ} )} {( {\sum }_{i ∈ {I}_{l}} \frac{\sqrt{ρ}}{γ} {ψ}_{l , i} {c}_{i} )}^{2} - {μ}_{l}^{2} ( \overline{θ} ) + {\tilde{σ}}_{l}^{2}\end{matrix} \qquad ( 15 )$$

thus, if the transmitted signal satisfies āₗ^{T}c̅=θ̅, the received signal is represented as:

$${\overline{y}}_{l} = {μ}_{l} ( \overline{θ} ) + \overline{{𝓏}_{l}} ( \overline{θ} ) \qquad ( 16 )$$

when K is sufficiently large, for a given θ̅, y̅ₗ is approximated as a Gaussian distribution with a mean μₗ(θ̅) and a variance σₗ²(θ̅); thus, the likelihood function is expressed as:

$$p ( {\overline{y}}_{l} \vert {\overline{a}}_{l}^{T} \overline{c} = \overline{θ} ) \approx \frac{1}{\sqrt{2 π} {σ}_{l} ( \overline{θ} )} exp ( - \frac{{( {\overline{y}}_{l} - {μ}_{l} ( \overline{θ} ) )}^{2}}{2 {σ}_{l}^{2} ( \overline{θ} )} ) \qquad ( 17 )$$

then using the total probability equation to obtain the likelihood function for the ICBs:

$$\begin{matrix}p ( {\overline{y}}_{l} \vert {\overline{a}}_{l}^{T} ⊗ \overline{c} = θ ) = {\sum }_{\overline{θ} : mod ( \overline{θ} , {2}^{m} ) = θ} p ( {\overline{y}}_{l} \vert {\overline{a}}_{l}^{T} \overline{c} = \overline{θ} ) p ( {\overline{a}}_{l}^{T} \overline{c} = \overline{θ} \vert {\overline{a}}_{l}^{T} ⊗ \overline{c} = θ ) \\ = \frac{1}{{2}^{m}} {\sum }_{\overline{θ} : mod ( \overline{θ} , {2}^{m} ) = θ} p ( {\overline{y}}_{l} \vert {\overline{a}}_{l}^{T} \overline{c} = \overline{θ} ) p ( {\overline{a}}_{l}^{T} \overline{c} = \overline{θ} )\end{matrix} \qquad ( 18 )$$

e) computation of the posterior probability of the ICBs

based on the likelihood function (18) for the ICBs, computing the posterior probability of the ICBs with a Bayes' equation:

$$p ( {a}_{l}^{T} ⊗ c = θ \vert {\overline{y}}_{l} ) = \frac{p ( {\overline{y}}_{l} \vert {a}_{l}^{T} ⊗ c = θ ) p ( {a}_{l}^{T} ⊗ c = θ )}{p ( {\overline{y}}_{l} )} = \frac{1}{η} p ( {\overline{y}}_{l} \vert {\overline{a}}_{l}^{T} ⊗ \overline{c} = θ ) \qquad ( 19 )$$

wherein η is a normalization factor ensuring a sum of all calculated soft decision terms

$$\frac{1}{η} p ( {\overline{y}}_{l} \vert {\overline{a}}_{l}^{T} ⊗ \overline{c} = θ ) , θ = 0 , … , {2}^{m} - 1$$

adds up to 1; a second step of the equation (19) utilizes an equal probability property of the ICBs:

$$p ( {a}_{l}^{T} ⊗ c = θ ) = \frac{1}{{2}^{m}} , θ = 0 , … , {2}^{m} - 1 ;$$

soft decision information, as a computation result of the a posteriori probability of the ICBs, is forwarded to a decoder of the channel-coding for decoding, so as to obtain a decision of the ICBs of multiple data stream.

The following procedure proves that the use of the above efficient calculation of the likelihood function (12) proposed by the method of the present invention can greatly reduce the complexity.

For the l-th ICB,

$${ω}_{H} ( {a}_{l} ) □ {\sum }_{i ∈ {I}_{l}} \vert {a}_{l , i} \vert ,$$

is defined as the “weight” of aₗ. The complexity of the ICB soft decision detection of the present invention is of the order of O(ω_{H}(aₗ)(2^{m}−1)+1). This is much lower than O(2^{mω(a}^{ₗ}⁾) when directly computing the function (12).

The complexity for all L ICBs is:

$$( {2}^{m} - 1 ) {\sum }_{l = 1}^{L} {ω}_{H} ( {a}_{l} ) + L \leq {2}^{m} {\sum }_{l = 1}^{L} {ω}_{H} ( {a}_{l} ) = {2}^{m} L \cdot {E}_{a} ( {ω}_{H} ( a ) ) \qquad ( 20 )$$

wherein Eₐ(ω_{H}(a)) denotes the average weight of the coefficient vector. The average complexity per user is O(2^{m}Eₐ(ω_{H}(a))), which is only E(ω_{H}(a)) times the complexity of single-user detection. Typically, Eₐ(ω_{H}(a)) is much smaller than the number K of data streams. For example, in a system with K=32 and N=32, the value of Eₐ(ω_{H}(a)) is no higher than 4.

The present invention further provides an application of the soft decision detection method in a lattice-code multiple-access system, wherein:

a K (stream) user single cell uplink multiple access model is considered here, wherein the communication in each cell is not interfered by other cells; the following settings are made for the clarity and simplicity of the model: each user is equipped with a single antenna and a receiver of a base station is equipped with N antennas; there is no inter-symbol interference in the model, which can be ensured by using orthogonal frequency division multiplexing (OFDM); a flat fading model is considered, wherein the channel coefficients of each coding block are constant; following the convention of studying uplink multiuser systems, an open loop system is considered in which the receiver of the base station does not provide a feedback link to give the transmitter channel state information (CSI) or adaptive coding modulation (ACM) information; each user transmits at the same target rate, and the channel state information H of the base station is known;

a) performing channel-coding and modulation

representing a 2^{m}-ary message data sequence of user i by a row vector bᵢ^{T}∈{0, 1, . . . , 2^{m}−1}, i=1, 2, . . . K; wherein k is the length of the message sequence; representing messages of all K users by a matrix B=[b₁, . . . , b_{K}]^{T} having a size of K×k; encoding the message data sequence of each user using a 2^{m}-ary ring code:

$$\begin{matrix}{c}_{i} = G ⊗ {b}_{i} , & i = 1 , 2 , … , K\end{matrix} \qquad ( 21 )$$

seeing step a) of embodiment 2 for operation of the channel-coding; then generating 2^{m}-PAM symbols with the equation (1), wherein all users transmit in a same band at a same time;

it should be noted that this coding and modulation are lattice codes, which have the algebraic nature of lattice codes; therefore, this multiple access scheme is also called “lattice code multiple access”.

b) receiving the signal

receiving the signal represented in the equation (2) by a receiver at a base station; applying a definition of the multiple data stream ICBs of the soft decision detection, and selecting L=K linearly independent integer coefficient vectors a₁^{T}, . . . , a_{K}^{T} by the base station according to channel state information H at the receiver; defining A=[a₁, . . . , a_{K}]^{T} as an integer coefficient matrix, which is full-ranked on Z₂_{^{m}}; and defining the ICBs of messages as:

$${u}_{l}^{T} □ {a}_{l}^{T} ⊗ B , l = 1 , … , K \qquad ( 22 )$$

wherein the receiver computes K ICBs u₁, . . . , u_{K} in advance, and then recovers the messages B=[b₁, . . . , b_{K}]^{T} of all the users; computation of uₗ is described in steps c) and d) below, and derivation of which is described in the embodiment;

c) performing soft decision detection of the ICBs

for the l-th ICB, using the method for the soft decision detection of the ICBs by the receiver, thereby calculating the a posteriori probability of the ICB of the channel-encoded K data streams in a symbol-by-symbol form:

$$p ( {a}_{l}^{T} ⊗ c [ t ] = θ \vert y [ t ] ) = \frac{1}{{2}^{m}} , θ = 0 , … , {2}^{m} - 1 , t = 1 , … , n \qquad ( 23 )$$

then forwarding the a posteriori probability to the decoder of the 2^{m}-ary channel-coding;

d) decoding the channel-coding

decoder output:

$$p ( {a}_{l}^{T} ⊗ b [ t ] = θ ) , θ = 0 , … , {2}^{m} - 1 , t = 1 , … , k \qquad ( 24 )$$

decision:

$${\hat{u}}_{t} [ t ] = {arg max}_{θ} p ( {a}_{l}^{T} ⊗ b [ t ] = θ ) \qquad ( 25 )$$

if the decision is correct, then obtaining the l-th ICB of the K users' message:

$${u}_{l} [ t ] = {a}_{l}^{T} ⊗ b [ t ] \qquad ( 26 )$$

and uₗ^{T}=[uₗ[1], . . . , uₗ[k]]; decoder operation is detailed in step d) of the embodiment 2;

e) recovering user data

performing the soft decision detection and decoding operations in parallel for the K ICBs to generate:

$$U = {[ {u}_{1} , … , {u}_{K} ]}^{T} = A ⊗ B \qquad ( 27 )$$

since A is full-ranked on Z₂_{^{m}}, there exists a unique inverse matrix A⁻¹:A⁻¹⊗A=I; using an operation:

$${A}^{- 1} ⊗ U = B \qquad ( 28 )$$

to recover all user message data B; and

f) performing simulation and performance evaluation

considering m=1 and m=2, corresponding to BPSK and 4-PAM, respectively; performing simulations, wherein frame error rate (FER) results are recorded and compared with a baseline scheme of iterative MMSE detection and decoding; performance of the lattice-code based multiple access scheme, which uses the ICB soft decision detection and decoding of the present invention, is significantly better than that of the baseline scheme. In addition, the method of the present invention has low complexity, parallel processing architecture and low processing delay, which does not have the convergence problem caused by the mismatch between the detector and the decoder in the iterative detection and decoding scheme.

The present invention further provides a lattice-based downlink MIMO broadcasting (LBC) system using the method for the soft decision detection of the multiple data stream ICBs, wherein:

the lattice-based downlink MIMO broadcasting (LBC) system utilizes the above ICB soft decision detection algorithm; considering the base station needs to deliver respective data streams to K users, the base station is equipped with N antennas, and the users are equipped with a single antenna, but it can be easily extended to multiple antennas at the user terminals; with OFDM modulation, there is no inter-symbol interference; the channel state information at the base station is known; the LBC system and processing method of the present invention are applicable to flat channel as well as frequency-selective channel models, and the frequency-selective channel model is described here, wherein if an interval between t′ and t is greater than a coherent bandwidth, then H[t]≠H[t′].

A block diagram of the system is shown in FIG. 4. The system comprises: a channel encoder, a codeword level precoder, a PAM modulator, a signal level precoder, an integer-combination soft decision detector, and a decoder; wherein the channel encoder, the codeword precoder, the PAM modulator, and the signal level precoder are arranged at the base station; and the integer-combination soft decision detector and the decoder are arranged at the user terminal; wherein:

a) the channel encoder encodes individual message sequences

a message sequence of user i is represented by a row vector bᵢ^{T}, i=1, 2, . . . K; wherein k is the length of the message sequence; for 2^{m}-ary bᵢ^{T}, the channel-coding adopts the equation (21);

in practice, bᵢ^{T} is modified as a binary data stream, which is encoded with binary LDPC or polarization codes; an output codeword sequence is mapped into elements of {0, 1, . . . , 2^{m}−1} using “m to 1” mapping, which is denoted as cᵢ^{T}∈{0, 1, . . . , 2^{m}−1}ⁿ, i=1, 2, . . . K; a column vector c[t]=[c₁[t], . . . , c_{K}[t]]^{T} indicates that the t-th symbol position of all K streams codeword sequences is in a downlink system; individual message sequences can be encoded using encoders with different rates;

b) the codeword precoder precodes the column vector c[t] obtained by the channel encoder at codeword level to obtain a precoded codeword sequence

the base station of the LBC system uses the method for the soft decision detection of the multiple data stream ICBs to select K linearly independent integer coefficient vectors a₁^{T}[t], . . . , a_{K}^{T}[t] for each signal sequence within a coherent bandwidth based on channel state information H[t] at the receiver, so that an integer coefficient matrix is A[t]=[a₁[t], . . . , a_{K}[t]]^{T}; since a frequency-selective channel is considered, if an interval between t′ and t is greater than the coherent bandwidth, then H[t]≠H[t′], so A[t]≠A[t′]; the LBC system requires A[t] to be full-ranked on Z₂_{^{m}} and there exists a unique inverse matrix A[t]⁻¹:A[t]⁻¹⊗A[t]=I;

in the LBC system, A⁻¹[t] is used to precode c[t] at the codeword level, so as to obtain the precoded codeword sequence:

$$v [ t ] = {A}^{- 1} [ t ] ⊗ c [ t ] , t = 1 , … , n \qquad ( 29 )$$

wherein v[t]=[v₁[t], . . . , v_{K}[t]]^{T}; and vₗ^{T}=[vₗ[1], . . . , vₗ[n]], l=1, . . . , K, which is the l-th precoded codeword sequence;

c) the PAM modulator:

a symbol sequence xₗ^{T}=[xₗ[1], . . . , xₗ[n]], l=1, . . . , K is mapped one by one to 2^{m}-PAM by the equation (1); a column vector x[t]=[x₁[t], . . . , x_{K}[t]]^{T} denotes the t-th symbol position of all K symbol sequences;

d) the signal level precoder precodes the precoded codeword sequence at a signal level to produce a transmission signal

the LBC system uses an integer forcing precoding matrix for signal level precoding, and the precoding matrix is:

$$P [ t ] = {H [ t ]}^{T} {( \frac{K}{ρ} I + H [ t ] {H [ t ]}^{T} )}^{- 1} A [ t ] \qquad ( 30 )$$

the base station produces the transmission signal after precoding, which is denoted as:

$$s [ t ] = P [ t ] x [ t ] , t = 1 , … , n \qquad ( 31 )$$

the transmission signal is transmitted via multiple antennas at the base station;

e) the ICB soft decision detector calculates an a posteriori probability of an ICB of a codeword sequence v[t] precoded by the codeword precoder in a symbol-by-symbol form

signals received by K users are denoted as:

$$y [ t ] = H [ t ] s [ t ] + z [ t ] = H [ t ] P [ t ] x [ t ] + z [ t ] , t = 1 , … , n \qquad ( 32 )$$

wherein the i-th element yᵢ[t] of the column vector y[t] is the signal received by the i-th user at a moment t; yᵢ^{T}=[yᵢ[1], . . . , yᵢ[n]], i=1, . . . , K denotes the signal sequence received by the i-th user;

a receiver of the user i is informed of a coefficient vector aᵢ^{T}[t]; the posterior probability of the ICBs about (pre-coded codeword) v[t] is computed symbol-by-symbol according to the step 4 of the method as:

$$p ( {a}_{i}^{T} [ t ] ⊗ v [ t ] = θ \vert {y}_{j} [ t ] ) , θ = 0 , … , {2}^{m} - 1 \qquad ( 33 )$$

the specific calculation steps of the a posteriori probability is described in the step 4 of the method, wherein c[t] in the step 4 should be replaced with v[t], and there is no difference in other operations;

because of the codeword level precoding with the equation (29):

$${a}_{i}^{T} [ t ] ⊗ v [ t ] = {a}_{i}^{T} [ t ] ⊗ {A}^{- 11} [ t ] ⊗ c [ t ] = {c}_{i} [ t ] , i = 1 , … , K \qquad ( 34 )$$

therefore, the calculated a posteriori probability of the ICBs of v[t] is the a posteriori probability of the codeword cᵢ[t]:

$$p ( {c}_{i} [ t ] = θ \vert {y}_{i} [ t ] ) = p ( {a}_{i}^{T} [ t ] ⊗ v [ t ] = θ \vert {y}_{i} [ t ] ) , i = 1 , … , K \qquad ( 35 )$$

it should be noted that even though the channel changes on each symbol, we still obtain the a posteriori probability of each user's codeword; thus, the method of the present invention is applicable to frequency selective channels;

f) the decoder performs hard decision on the a posteriori probability obtained by the ICB soft decision detector, so as to obtain a desired decoding result of the message sequence

the a posteriori probability is forwarded to the decoder of channel-coding, and each user performs one decoding, a decoder output of the user i is:

$$p ( {b}_{i} [ t ] ) , t = 1 , … , k \qquad ( 36 )$$

the desired decoding result of the message sequence is obtained by the hard decision.

In practice, it is sufficient to use iterative BP decoding for LDPC codes and serial decoding or serial list decoding for polarized codes.

The present invention also provides a lattice-based cell-free MIMO system for performing the soft decision detection of the ICBs, comprising:

a K-user cell-free MIMO network model with a total of N_{BS} distributed units DU, wherein each DU is connected to a central unit CU via a backhaul link BH; the capacity of the BH link is constrained to be of the same order of magnitude as that of an air interface; each user is considered to have a single antenna, and the base station receiver has N antennas.

A block diagram of the described cell-free MIMO system is shown in FIG. 8, wherein the lattice-based cell-free MIMO system further comprises: a channel-coding and modulation device, a cell-free network channel, an ICB soft decision detector, a decoder of channel-coding, and a user data decoder for CU;

a) the channel-coding and modulation device encodes each sequence of user message data

a 2^{m}-ary message data sequence of user i is represented by a row vector bᵢ^{T}∈{0, 1, . . . , 2^{m}−1}^{k}, i=1, 2, . . . K; wherein k is the length of the message data sequence; message data of all K users is represented by a matrix B=[b₁, . . . , b_{K}]^{T} having a size of K×k; the message data sequence of each user is encoded using a 2^{m}-element ring code: cᵢ=G⊗bᵢ, i=1, 2, . . . , K; then 2^{m}-PAM symbols are generated with the equation (1), and all users transmit in a same band at the same time;

b) the cell-free network channel receives signals from each distributed base station

the signal received by the receiver at the base station j is the same as that of the equation (2), which is denoted as:

$${Y}_{j} = {\sum }_{i = 1}^{K} \sqrt{ρ} {h}_{j , i} {x}_{i}^{T} + {Z}_{j} = \sqrt{ρ} {H}_{j} X + {Z}_{j} , j = 1 , … , {N}_{B S} \qquad ( 37 )$$

the base station j is designed to generate Lⱼ ICBs about the K streams of messages B=[b₁, . . . , b_{K}]^{T}, and Lⱼ is required to be as large as possible without exceeding the BH capacity limit; according to channel state information Hⱼ at the receiver and the processes described in the step 3 of the method, the base station selects Lⱼ linearly independent integer coefficient vectors a_{j,1}^{T}, . . . , a_{j,L}_{ⱼ}^{T}, and Aⱼ=[a_{j,1}, . . . , a_{j,K}]^{T} is the integer coefficient matrix chosen by the base station j;

c) the ICB soft decision detector calculates an a posteriori probability of an ICB of the K data streams encoded by channel-coding in a symbol-by-symbol form

the base station j uses ICB soft decision and the ICB soft decision in the step 4 of the method to compute the a posteriori probability of the l-th ICB symbol-by-symbol, so as to obtain the a posteriori probability of the ICB of the K data streams encoded by channel-coding:

$$p ( {a}_{j , l}^{T} ⊗ c [ t ] = θ \vert {y}_{j} [ t ] ) = \frac{1}{{2}^{m}} , θ = 0 , … , {2}^{m} - 1 , t = 1 , … , n \qquad ( 38 )$$

then the a posteriori probability is forwarded to the decoder of the 2^{m}-ary channel-coding;

d) the decoder of channel-coding decodes and outputs the a posteriori probability

decoder output:

$$p ( {a}_{j , l}^{T} ⊗ b [ t ] = θ ) , θ = 0 , … , {2}^{m} - 1 , t = 1 , … , k \qquad ( 39 )$$

decision:

$${\hat{u}}_{j , l} [ t ] = {arg max}_{θ} p ( {a}_{j , l}^{T} ⊗ b [ t ] = θ ) \qquad ( 40 )$$

if the decision is correct, the l-th ICB u_{j,l}^{T}=[u_{j,l}[1], . . . , u_{j,l}[k]] is obtained; the decoder operation is detailed in step 5 d) of the embodiment;

e) the user data decoder for CU generates a decision for ICBs of message

the soft decision detection and decoding operations of Lⱼ ICBs of the base station j are carried out in parallel to obtain Uⱼ=[u_{j,1}, . . . , u_{j,L}_{ⱼ}]^{T}Aⱼ⊗B, which is then forwarded to the CU through the BH;

meanwhile, the soft decision and decoding operations of other base stations generate U₁, . . . , U_{N}_{_{BS}}; the CU collects all the ICBs;

$$U = {[ {U}_{1}^{T} , … , {U}_{{N}_{BS}}^{T} ]}^{T} = {A}_{CU} ⊗ B \qquad ( 41 )$$

if A_{CU}=[A₁^{T}, . . . , A_{N}_{_{BS}}^{T}]^{T} is full-ranked on Z₂_{^{m}}, there exists a unique inverse matrix A_{CU}⁻¹:A_{CU}⁻¹⊗A_{CU}=I, and the CU can recover all users' message B by

$${A}_{CU}^{- 1} ⊗ U = B \qquad ( 42 )$$

It should be noted that the total backhaul link BH usage of the system is

$$\frac{k m}{n} {\sum }_{j = 1}^{{N}_{BS}} {L}_{j}$$

bits/symbol, which is of the same order of magnitude as the capacity of the air interface.

The present invention considers different number of distributed base stations, different number of users and antennas, and different code rates for simulation, wherein the frame error rate (FER) results are recorded and compared with those of the baseline schemes. With the ICB soft decision detection and decoding of the present invention, the performance of the cell-free MIMO scheme is significantly better than the baseline scheme, and the BH utilization rate is higher.

### Advantages and Efficacy

The present invention proposes the method and the system for the soft decision detection of the ICBs of multiple data streams with low complexity, parallel processing architecture and low processing latency, which allows decoding performance to be close to the capacity limit. The method of the present invention enables the theoretical gains of lattice codes, compute-forward, physical-layer network coding, LR, and IF to be honored in real communication systems. This solves the problem of huge performance loss in conventional linear detectors and precoders, and the non-convergence problem due to the matching of detectors and decoders in iterative detection. The results of the present invention are highly generalized, resulting in high-performance uplink multiuser detection, downlink precoding, and cell-free network distributed base station processing, which can also be used for inter-symbol or inter-carrier interference processing. In uplink systems, “full diversity gain” can be obtained and overload transmission with K/N>300% is supported. In downlink systems, “full multiplexing” of space domain can be achieved with linear precoding, which is close to the performance limit of MIMO broadcast channel. The present invention is particularly suitable for cell-free networks to achieve better efficiency in the utilization of the air interface and the backhaul link.

### BRIEF DESCRIPTION OF THE DRAWINGS

FIG. 1 is a block diagram of soft decision detection and decoding for multiple data stream ICBs according to embodiment 1 of the present invention;

FIG. 2 is performance curves of embodiment 2 of the present invention using ICB soft decision detection and decoding in an uplink lattice-code multiple-access system; wherein the horizontal axis indicates SNR for a single user and the vertical axis indicates frame error rate; rate 1/2 binary LDPC code of length k=480 with BPSK modulation are adopted, and per-user spectral efficiency is 1/2 bit/symbol; the number of receiver antennas is N=8, the number of users is K=16, 20, 24, and the total spectral efficiency is 8, 10, 12 bits/symbol, respectively; the baseline represents iterative MMSE detection; and three approaches are considered for the selection of coefficient matrix A for lattice-code multiple-access (LCMA): rank-constrained sphere decoding (RC-SD), HKZ and LLL algorithms;

FIG. 3 is FER performance curve of the embodiment 2 of the present invention using the ICB soft decision detection and decoding in the uplink lattice-code multiple-access (LCMA) system, indicating the FER performance when receiver antenna number N=4 and user number K=8; wherein quadrature coding with 4-PAM modulation is used, and channel-coding adopts rate 1/2 4-ary LDPC code with code length k=256, and per-user spectral efficiency of 1 bit/symbol; the total spectral efficiency is 8 bits/symbol; the performance of ICB soft decision detection method I and II is shown here; and the interference-free lower bound (LB) provides a lowest bit error rate bounds of the system;

FIG. 4 is a block diagram of a lattice-based downlink MIMO broadcast system according to embodiment 3 of the present invention;

FIG. 5 is bit error rate (BER) performance curves of the lattice-based downlink broadcasting system under a slow fading channel according to the embodiment 3 of the present invention; wherein regularized integer-forcing (RIF) is adopted for precoding, the number of receiver antennas is N=4 and the number of users is K=4; 5-ary IRA coding and 5-PAM modulation are used, and at least 500 channel realizations are performed for each SNR during the simulation, with a code length of 50000, and the average code rate of 1/2; the method is applicable to any order of PAM modulation, number of antennas, and number of users; the baseline system considers zero-forcing (ZF) and regularized ZF (RZF) schemes;

FIG. 6 is comparison between BER performance and theoretical performance limit of the downlink lattice-code multiple-access system under the slow fading channel according to the embodiment 3 of the present invention; wherein the number of the receiver antennas is N=4 and the number of the users is K=4; discrete points marked with asterisks indicate the BER performance obtained by applying ICB soft decision algorithm and decoding of the present invention; it can be seen that the gap between the theoretical upper bounds of the lattice-based downlink MIMO broadcasting system and the RIF is only around 1.2-1.3 dB; meanwhile, performance improvement is more than 5 dB compared with both the regularized zero-forcing RZF precoding and the ZF precoding of the baseline;

FIG. 7 illustrates BER performance of a downlink receiver under a fast fading channel according to the embodiment 3 of the present invention with different number of users and modulation orders; wherein rate 1/2 2^{m}-ary IRA coding and the corresponding modulation order are used with a code length of k=50000; it can be seen that when using the ICB soft decision detection of the present invention, the gap between the theoretical bounds of the lattice-based MIMO broadcasting system and the RIF is less than 1 dB;

FIG. 8 is a block diagram of a lattice-based cell-free MIMO system according to embodiment 4 of the present invention;

FIG. 9 illustrates FER performance of the lattice-based uplink cell-free MIMO system according to the embodiment 4 of the present invention; wherein there are 4 distributed base stations, each with N=8 antennas, and K=24 users; binary coding with BPSK modulation is used, and channel-coding adopts rate 1/2 length 480 LDPC code of 5G NR standard, the per-user spectral efficiency is 1/2 bits/symbol, and the total spectral efficiency is 12 bits/symbol, the FIG. 9 shows outage probability (OP) and frame error rate performance; the baseline scheme is scalar quantization and compress-forward schemes; it can be seen that there is a significant performance gain for lattice-based network coding (LNC);

FIG. 10 illustrates FER performance of the lattice-based uplink cell-free MIMO system according to the embodiment 4 of the present invention; wherein there are 4 distributed base stations, each with N=8 antennas, and K=12 users; quadratic LDPC coding with 4-PAM modulation is used, and the channel-coding adopts rate 1/2 length 256 4-ary LDPC code, and per-user spectral efficiency of 1 bit/symbol; the total spectral efficiency is 12 bits/symbol;

FIG. 11 illustrates performance of the lattice-based uplink cell-free MIMO system according to the embodiment 4 of the present invention; wherein there are 1, 2, 4, 8 distributed base stations, each with N=8 antennas, and K=24 users; rate 1/2 length 480 binary LDPC code with BPSK modulation is used; the per-user spectral efficiency is 1 bits/symbol, and the total spectral efficiency is 12 bits/symbol; and

FIGS. 12a and 12b illustrate performance of the lattice-based uplink cell-free MIMO system according to the embodiment 4 of the present invention; wherein there are 4 distributed base stations, each with N=32 antennas, and K=32, 40, 48 users; the quadratic LDPC coding with 4-PAM modulation is used with the per-user spectral efficiency of 1 bit/symbol and a total spectral efficiency of 32, 40, 48 bits/symbol; wherein FIG. 12a shows outage probability performance and FIG. 12b shows BH consumption; it can be seen that the transmission rate and BH consumption are of the same order of magnitude.

### DETAILED DESCRIPTION OF THE PREFERRED EMBODIMENT

In order to further illustrate the principles, methods, features, and performance advantages of the present invention, embodiments thereof will be described in detail below.

Embodiment 1 provides a method for soft decision detection of multiple data stream ICBs, comprising steps as follows.

Step 1: sending a signal

considering K streams of messages, denoting by row vectors b₁^{T}, . . . , b_{K}^{T}; denoting the i-th data stream after channel-coding with a row vector cᵢ^{T}, i=1, 2, . . . , K, wherein a data stream length is n; denoting the t-th symbol position of cᵢ^{T} with cᵢ[t], t=1, . . . , n; and denoting the t-th symbol positon of all the K data streams with a column vector c[t]=[c₁[t], . . . , c_{K}[t]]^{T};

considering 2^{m}-ary channel-coding, m=1, 2, . . . , then cᵢ[t]∈{0, . . . , 2^{m}−1}, wherein elements of cᵢ[t] are nonnegative integers no greater than 2^{m}−1; mapping the sequence of channel-coded data streams symbol-by-symbol into a 2^{m}-PAM modulated signal sequence:

$${x}_{i}^{T} = \frac{1}{γ} ( {c}_{i}^{T} - \frac{{2}^{m} - 1}{2} ) ∈ \frac{1}{γ} {\{ \frac{1 - {2}^{m}}{2} , … , \frac{{2}^{m} - 1}{2} \}}^{n} , i = 1 , … , K , \qquad ( 1 )$$

wherein γ is a normalization factor ensuring average energy of the sequence xᵢ^{T} is 1; elements of xᵢ^{T} are all integers divided by γ; all K streams signals are transmitted simultaneously;

for a complex model, adopting two independent codes and modulations, and transmitting in both in-phase and quadrature parts to form 2^{2m}-QAM modulation of I/Q, which is in line with the 2^{m}-PAM and 2^{2m}-QAM modulations that are widely used in mainstream communication systems.

Step 2: receiving the signal

considering a spatial dimension of received signals at the receiver as N; (for example, the receiver is equipped with N antennas, each providing one observation; alternatively, the system has a spreading sequence length of N, with each code-slice signal providing one observation)

for a real-valued model, denoting the received signal as:

$$Y = {\sum }_{i = 1}^{K} \sqrt{ρ} {h}_{i} {x}_{i}^{T} + Z = \sqrt{ρ} HX + Z \qquad ( 2 )$$

wherein hᵢ denotes a channel vector of N observations from the i-th stream signal to the receiver; H=[h₁, . . . , h_{K}] denotes a channel matrix, containing the channel vectors corresponding to all stream signals; a matrix X=[x₁, . . . , x_{K}]^{T} denotes a sequence of all the K streams of signals, wherein the i-th row represents the i-th stream signal; Z denotes an additive white Gaussian noise (AWGN) matrix, whose elements are independently and identically distributed zero-mean unit-variance Gaussian noises; ρ denotes the average energy of the stream signals, which is equivalent to SNR; Y=[y[1], . . . , y[n]], y[t] is a received signal vector for the t-th symbol position;

wherein a complex-valued model can be represented by a real-valued model of doubled dimension:

$$[ \begin{matrix}{Y}^{Re} \\ {Y}^{Im}\end{matrix} ] = \sqrt{ρ} [ \begin{matrix}{H}^{Re} & - {H}^{Im} \\ {H}^{Im} & {H}^{Re}\end{matrix} ] [ \begin{matrix}{X}^{Re} \\ {X}^{Im}\end{matrix} ] + [ \begin{matrix}{Z}^{Re} \\ {Z}^{Im}\end{matrix} ] \qquad ( 3 )$$

for clarity of presentation, a real-valued model is described here.

Step 3: defining the multiple data stream integer-combinations

considering a not all zero integer coefficient vector a^{T}∈Z^{K} with length K; denoting an integer-combination (ICB) on Z₂_{^{m}} with respect to c[t] as:

$${a}^{T} ⊗ c [ t ] = mod ( {a}^{T} c [ t ] , {2}^{m} ) , t = 1 , … , n \qquad ( 4 )$$

wherein mod (□, 2^{m}) means a mod 2^{m} operation, and the range of values of the ICB is a^{T}⊗c[t]∈{0, . . . , 2^{m}−1};

in general, L ICBs are denoted as:

$${a}_{l}^{T} ⊗ c [ t ] , l = 1 , … , L , t = 1 , … , n , \qquad ( 5 )$$

wherein aₗ^{T}∈Z^{K} denotes an integer coefficient vector corresponding to an l-th ICB.

The present invention is applicable to any coefficient vector a₁^{T}, . . . , a_{L}^{T}, and is not focused on selection of the optimal a₁^{T}, . . . , a_{L}^{T}; for the sake of completeness of the specification, a method for selecting the optimal a₁^{T}, . . . , a_{L}^{T} is briefly described below.

This step requires identifying an optimal integer coefficient matrix A, A∈□^{L×K} According to the embodiment, two methods can be used.

### Method 1: Lenstra-Lenstra-Lovisz (LLL) Lattice Reduction

considering a channel matrix H, and eigen-decomposing an MMSE matrix (I+ρH^{T}H)⁻¹ thereof to obtain:

$${( I + ρ {H}^{T} H )}^{- 1} = Ψ Σ {Ψ}^{T}$$

wherein Ψ is a matrix consisting of eigenvectors; the optimal coefficient matrix A is a solution of the following optimization problem:

$$A = {arg min}_{rank ( A ) = L} {max}_{l} {‖ {\sum }^{1 / 2} {Ψ}^{T} {a}_{l} ‖}^{2} ,$$

the optimization problem can be described as follows: using L to denote all the lattice points formed by base vector sets Σ^{1/2}Ψ^{T}; finding a set of L lattice points in L that have different orientations and the shortest maximum length; the optimization problem is NP-hard, but several conventional algorithms can be used to find near-optimal solution in polynomial time, such as the LLL algorithm.

Definition of LLL reduced basis is: d₁, . . . , d_{M} is a lattice basis set whose resulting lattice space is denoted as L. d₁, . . . , d_{M} is processed with Schmidt orthogonalization to obtain a vector set d*₁, . . . , d*_{M}. If the vector set satisfies:

1. size-reduce condition: for any m₂<m₁≤M,

$$\vert {w}_{{m}_{1} , {m}_{2}} \vert \leq \frac{1}{2} ,$$

wherein

$${w}_{{m}_{1} , {m}_{2}} = \frac{〈 {d}_{{m}_{1}} , {d}_{{m}_{2}}^{*} 〉}{〈 {d}_{{m}_{2}}^{*} , {d}_{{m}_{2}}^{*} 〉}$$

is a Schmidt orthogonalization coefficient and [symbol] dₘ_{₁},dₘ_{₂} [symbol] is an inner product operation; and

2. Lovasz condition: for any dₘ₋₁,dₘ(m=2, . . . , M), ∥d*ₘ∥²≥(α−w_{m,m-1}²)∥d*ₘ₋₁∥², wherein

$$α ∈ ( \frac{1}{4} , 1 ) ;$$

then d₁, . . . , d_{M} is a set of LLL reduced basis for the lattice L generated by the basis vectors Σ^{1/2}Ψ^{T}. The size-reduce condition ensures that the vectors in the LLL reduced basis are relatively short and approximately independent, and the Lovasz condition roughly orders the base vectors. Since the LLL reduced basis is not strictly the shortest base vector in L, the result obtained by the LLL algorithm is not optimal, but the near-optimal solution which is sufficient to obtain better performance.

The LLL algorithm finds the LLL reduced basis in the lattice space L formed by Σ^{1/2}Ψ^{T} column vectors, which is the approximate shortest base vector in L. A linear transformation matrix between Σ^{1/2}Ψ^{T} and the LLL reduced basis is the desired optimal integer coefficient matrix.

```
  Algorithm 1: Solving the optimal A with LLL
  Inputs: channel parameter H , signal-to-noise ratio ρ , Lovasz parameter
  α ;
  Output: integer coefficient matrix A ;
  [Ψ,Σ]=eig((I + ρH^{T}H)⁻¹) , wherein Σ is an eigenvalue diagonal matrix
and Ψ is an orthogonal matrix;
  D = Σ^{1/2}Ψ^{T}
  D₁ = LLL(D,α)
  A = D⁻¹D₁
  return A
```

wherein eig(⋅) is an eigenvalue decomposition function and LLL(⋅) is the LLL algorithm. In the embodiment, the channel parameter H and the SNR are known, and the optimal coefficient matrix A can be obtained by using the algorithm 1, so as to obtain an optimal linear filtering matrix W to complete the decoding process. In the present invention, α=0.99.

### Method 2: Sphere Decoding

Performing Choleski decomposition on ΨΣΨ^{T}, then ΨΣΨ^{T}=Π529 ^{T}, wherein Π is an upper triangular matrix; setting a radius r and searching for all lattice points contained within that radius using a tree search based list sphere decoding method centered on the zero point to form a list L1; among candidate vectors of the list, using a greedy algorithm to find L integer coefficient vectors a₁^{T}, . . . , a_{L}^{T} with rank L on an integer ring Z₂_{^{m}}, so as to obtain the coefficient matrix A; if the rank L cannot be reached, increasing the radius r moderately and re-running the list spherical decoding until the rank condition is satisfied.

The coefficient matrix A obtained by the sphere decoding is closer to the optimal solution than that of the LLL algorithm, but the complexity increases.

Step 4: (core algorithm of the present invention)

a) linear filter

the ICB soft decision detection method proposed in the present invention is applicable to any matrix W to implement the linear filtering indicated in the equation (7), the regularized integer forcing (RIF) method is used as an example, wherein the 1-th row of the filtered matrix W is

$${w}_{l}^{T} = {a}_{l}^{T} {{H}^{T} ( {ρHH}^{T} + {I}_{N} )}^{- 1} , l = 1 , … , L \qquad ( 48 )$$

in the embodiment, an N-dimensional received signal is converted into an L-stream single-dimensional signal by RIF filtering; each stream is then used to compute an a posteriori probability for one ICB; it should be noted that the method of the present invention is applicable to any W; in practice, regularized integer forcing (RIF) can be used to form the filtering matrix W;

b) signal representation

in order to calculate the posterior probability of aₗ^{T}⊗c, equivalently representing the received signals defined by the equation (7) as follows; using Iₗ␣{i:a_{l,i}≠0} to collect positions of non-zero terms of aₗ, wherein Iₗ^{c} denotes a complement, and ω(aₗ)□|Iₗ| denotes the quantity of the non-zero terms of aₗ; then the equation (7) is expressed as:

$${\tilde{y}}_{l} = {\sum }_{i ∈ {I}_{i}^{c}} \sqrt{ρ} {ψ}_{l , i} {x}_{i} + {\sum }_{i ∈ {I}_{i}^{c}} \sqrt{ρ} {ψ}_{l , i} {x}_{i} + {\overline{z}}_{l} = {\sum }_{i ∈ {I}_{i}} \sqrt{ρ} {ψ}_{l , i} {x}_{i} + {ξ}_{l} . ; \qquad ( 8 )$$

wherein

$${\sum }_{i ∈ {I}_{i}} \sqrt{ρ} {ψ}_{l , i} {x}_{i}$$

denotes superposition of signals of ω(aₗ) users with non-zero coefficients of aₗ, which is a useful signal part for computation of the ICBs;

$${\sum }_{i ∈ {I}_{i}^{c}} \sqrt{ρ} {ψ}_{l , i} {x}_{i}$$

also contains signals of remaining K−ω(aₗ) users, which corresponds to zero coefficients of aₗ, and is not relevant to the ICBs;

$${ξ}_{l} = {\sum }_{i ∈ {I}_{i}^{c}} \sqrt{ρ} {ψ}_{l , i} {x}_{i} + {\tilde{z}}_{l}$$

is considered as equivalent noise, which is not relevant to the useful signal part; for a sufficiently large K, |Iₗ^{c}| is also sufficiently large; according to central limit theorem, the equivalent noise ξₗ follows a Gaussian distribution, with zero mean and variance

$${\tilde{σ}}_{l}^{2} = {γ}^{2} ( ρ {\sum }_{i ∈ {I}_{i}^{c}} {ψ}_{l , i}^{2} + 1 ) ;$$

using a bijection between xᵢ and cᵢ in the equation (1), which is

$${x}_{i} = \frac{1}{γ} ( {c}_{i} - \frac{{2}^{m} - 1}{2} ) ,$$

to further simplify the equation (8) as:

$${\tilde{y}}_{l} = \sqrt{\frac{ρ}{γ}} {\sum }_{i ∈ {I}_{i}} {ψ}_{l , i} {c}_{i} + {ξ}_{l} - {φ}_{l} \qquad ( 9 )$$

wherein

$${φ}_{l} = \frac{\sqrt{ρ}}{γ} \frac{{2}^{m} - 1}{2} {\sum }_{i ∈ {I}_{i}} {ψ}_{l , i}$$

is not relevant to the signals, which resembles a DC component and is intended to convert the signal from {−1, +1} to {0,1};

$${φ}_{l} = \frac{\sqrt{ρ}}{γ} \frac{{2}^{m} - 1}{2} {\sum }_{i ∈ {I}_{i}} {ψ}_{l , i}$$

is compensated by y̅ₗ=\tilde{y}^{l}+φₗ to obtain:

$${\overline{y}}_{l} = \frac{\sqrt{ρ}}{γ} {\sum }_{i ∈ {I}_{i}} {ψ}_{l , i} {c}_{i} + {ξ}_{l} \qquad ( 10 )$$

then, only signals of the users corresponding to non-zero elements in aₗ exist in a signal portion of the equation (1); and computation of the posterior probability of the ICBs is denoted as:

$${\overline{y}}_{l} \to p ( {a}_{l}^{T} ⊗ c = θ \vert {\overline{y}}_{l} ) , θ ∈ \{ 0 , … , {2}^{m} - 1 \} , \qquad ( 11 )$$

wherein l=1, . . . , L;

c) exact computation of the likelihood function for the ICBs

to find the posterior probability in the equation (11), the likelihood function p(y̅ₗ|aₗ^{T}⊗c=0) is necessary, which is calculated as follows:

a vector āₗ contains only non-zero elements of aₗ and a vector c̅ contains only portions of c that corresponds to the non-zero elements of aₗ (the portion that belongs to Iₗ); lengths of āₗ and c̅ are ω(aₗ)=|Iₗ|; the total probability equation is:

$$p ( {\overline{y}}_{l} \vert {a}_{l}^{T} ⊗ c = θ ) = p ( {\overline{y}}_{l} \vert {\overline{a}}_{l}^{T} ⊗ \overline{c} = θ ) = {\sum }_{\overline{c} : {\overline{a}}_{l}^{T} ⊗ \overline{c} = θ} p ( {\overline{y}}_{l} \vert \overline{c} ) p ( \overline{c} \vert {\overline{a}}_{l}^{T} ⊗ \overline{c} = θ ) \qquad ( 12 )$$

then the equation (10) is modified as:

$$p ( {\overline{y}}_{l} \vert \overline{c} ) = \frac{1}{\sqrt{2 π}} exp ( \frac{- {\vert {\overline{y}}_{l} - \frac{\sqrt{ρ}}{γ} {\sum }_{i ∈ {I}_{i}} {ψ}_{l , i} {c}_{i} \vert}^{2}}{2 {\tilde{σ}}_{l}^{2}} ) \qquad ( 13 )$$

if the likelihood function (12) is solved directly here, it is necessary to compute p(y̅ₗ|c̅) values of 2^{mω(a}^{ₗ}⁾ candidate c̅ vectors, and thus its complexity is of the order of O (2^{m|ω(a}^{ₗ}⁾); therefore, the present invention provides an efficient method for computing the likelihood function (12);

d) computation of a low-complexity likelihood function based on Gaussian approximation

the high complexity of the exact computation of the likelihood function arises from the exhaustive enumeration of candidate sets that satisfy the linear equation aₗ^{T}c=θ̅; the central idea behind the use of Gaussian approximation is that when K is sufficiently large, for a given θ̅, the set of channel reception values corresponding to the candidate set can be approximated as a Gaussian distribution with a mean μₗ(θ̅) and a variance σₗ²(θ̅); three statistical values are required to determine this Gaussian distribution: 1) the prior probability p(θ̅), 2) the conditional mean μₗ(θ̅), and 3) the conditional variance σₗ²(θ̅), which will be given in detail below:

Note that since these statistical values need to be computed only once at the coherence time (or coherence bandwidth) of each channel realization (n-long sequence), the computational cost of these statistical values can be neglected if n is sufficiently large;

to simplify the description, the ICB index l is omitted below;

1) calculation of the priori probability p(θ̅)

the prior probability p(θ̅) can be determined from the distribution of the number of candidate sets; nₖ[θ̅] denotes the number of [a₁, . . . , aₖ] that satisfy

$${\sum }_{i = 1 , … , k} {a}_{i} {c}_{i} = \overline{θ} ;$$

when k=1, it is clear that there is n₁[θ̅]=1; nₖ[θ̅] can be obtained by:

$${n}_{k} [ \overline{θ} ] = {\sum }_{τ = 0 , … , {2}^{m} - 1} {n}_{k - 1} [ \overline{θ} - {a}_{i} τ ] \qquad ( 55 )$$

at the k-th level,

$$\overline{θ} = ( {2}^{m} - 1 ) {\sum }_{{a}_{i} < 0 , i = 1 , … , k} {a}_{i} , … , ( {2}^{m} - 1 ) {\sum }_{{a}_{i} > 0 , i = 1 , … k} {a}_{i} ,$$

until K′=ω(a); in total, the number of additive operations this takes is no more than

$${\sum }_{k = 1}^{{K}^{′}} ( {ω}_{H} ( [ {a}_{1} , … , {a}_{k} ] ) ( {2}^{m} - 1 ) + 1 ) ( {2}^{m} - 1 ) \approx {\sum }_{k = 1}^{{K}^{′}} {ω}_{H} ( [ {a}_{1} , … , {a}_{k} ] ) {( {2}^{m} - 1 )}^{2} \qquad ( 56 )$$

no multiplication is involved; the prior probability p(θ̅) can be obtained from

$$p ( \overline{θ} ) = \frac{{n}_{{K}^{′}} [ \overline{θ} ]}{{\sum }_{\overline{θ}} {n}_{{K}^{′}} [ \overline{θ} ]} ;$$

2) conditional mean μₗ(θ̅)

\tilde{μ}ₖ[θ̅] denotes the sum of the received signals with probabilistic occurrence of the elements in the candidate set corresponding to

$${\sum }_{i = 1 , … , k} {a}_{i} {c}_{i} = \overline{θ} ,$$

which is called an equal probability sum of the candidate sets; the conditional mean is obtained by dividing the equal probability sum by the number of candidate sets; when k=0, it is clear that \tilde{μ}ₖ[θ̅]=0; the conditional mean is obtained by performing the following operations in sequence:

$${\tilde{μ}}_{k} [ \overline{θ} ] = {\sum }_{τ = 0 , … , {2}^{m} - 1} {\tilde{μ}}_{k - 1} [ \overline{θ} - {a}_{i} τ ] + τ \sqrt{ρ} {ψ}_{k} . \qquad ( 57 )$$

until K′=ω(a), the conditional mean is calculated from μ(θ̅)=\tilde{μ}_{K′}[θ̅]/n_{K′}[θ̅];

3) conditional variance σₗ²(θ̅)

similarly, defining an equal probability sum of squares as

$${ϑ}_{k} [ \overline{θ} ] = {\sum }_{c ∈ Ω ( \overline{θ} )} {( {\sum }_{i ∈ I} \sqrt{ρ} {ψ}_{i} {c}_{i} )}^{2} ;$$

and executing the following operations in sequence:

$${ϑ}_{k} [ \overline{θ} ] = {\sum }_{τ = 0 , … , {2}^{m} 1} ( {ϑ}_{k - 1} [ \overline{θ} - {a}_{k} τ ] + 2 τ \sqrt{ρ} {ψ}_{i} {\tilde{μ}}_{k - 1} [ \overline{θ} - {a}_{k} τ ] + {( τ \sqrt{ρ} {ψ}_{i} )}^{2} ) . \qquad ( 58 )$$

until the layer K′ is reached, the conditional variance is obtained from the following equation:

$${σ}^{2} ( \overline{θ} ) = {ϑ}_{{K}^{′}} [ \overline{θ} ] / {n}_{{K}^{′}} [ \overline{θ} ] - {μ}^{2} ( \overline{θ} ) + {γ}^{2} {\overline{σ}}^{2} \qquad ( 59 )$$

the above method is referred to as ICB soft decision method I;

in practice, acquisition of statistical values can be simplified if RIF is used, wherein the signal is represented as

$${\overline{y}}_{l} = {\sum }_{i ∈ {I}_{i}} \frac{\sqrt{ρ}}{γ} {ψ}_{l , i} {c}_{i} + \overline{{z}_{l}} = {\sum }_{i ∈ {I}_{i}} \frac{\sqrt{ρ}}{γ} {a}_{l , i} {c}_{i} + {e}_{l} ( math . ) genus \qquad ( 60 )$$

estimated error term is

$${e}_{l} = {\sum }_{i ∈ {I}_{i}} \frac{\sqrt{ρ}}{γ} ( {ψ}_{l , i} - {a}_{l , i} ) {c}_{i} + {\overline{z}}_{l} . \qquad ( 61 )$$

wherein an error term eₗ is correlated with a useful signal part

$${\sum }_{i ∈ {I}_{i}} {a}_{l , i} {c}_{i} ,$$

which leads to μₗ(θ̅)≠θ̅ and σₗ²(θ̅)≠\tilde{σ}ₗ², computing them according to equations (57) and (59), respectively;

for a sufficiently large K, central limit theorem can be applied to eₗ, so as to approximate eₗ as a Gaussian random variable with a variance E(eₗ²); it can be easily proved that the MSE of eₗ has a closed-form expression:

$$E ( {e}_{l}^{2} ) = {{a}_{l}^{T} ( ρ {H}^{T} H + I )}^{- 1} {a}_{l}^{T} . \qquad ( 62 )$$

in addition, by disregarding the bias in the estimation error term, the mean value of eₗ is approximated as zero; thus, the equation (17) is further simplified to:

$$p ( {a}_{l}^{T} c = θ \vert {\overline{y}}_{l} ) \approx \frac{1}{η} {\sum }_{\overline{θ} : {a}_{l}^{T} ⊗ c = θ} exp ( - \frac{{( {\overline{y}}_{l} - \overline{θ} )}^{2}}{2 E ( {e}_{l}^{2} )} ) p ( \overline{θ} ) \qquad ( 63 )$$

this method is called ICB soft decision method II;

note that the priori probability p(θ̅) is calculated as mentioned above, while the calculation of the conditional mean and variance can be greatly simplified;

for a smaller K, using the ICB Soft decision method I since the loss of ICB soft decision method II may be more significant; for a sufficiently large K, using the ICB soft decision method II to have a sufficiently small performance gap;

e) computation of the posterior probability of the ICBs

based on the likelihood function (18) for the ICBs, computing the posterior probability of the ICBs with a Bayes' equation:

$$p ( {a}_{l}^{T} ⊗ c = θ \vert {\overline{y}}_{l} ) = \frac{p ( {\overline{y}}_{l} \vert {a}_{l}^{T} ⊗ c = θ ) p ( {a}_{l}^{T} ⊗ c = θ )}{p ( {\overline{y}}_{l} )} = \frac{1}{η} p ( {\overline{y}}_{l} \vert {\overline{a}}_{l}^{T} ⊗ \overline{c} = θ ) \qquad ( 19 )$$

wherein η is a normalization factor ensuring the sum of all calculated soft decision terms

$$\frac{1}{η} p ( {\overline{y}}_{l} \vert {\overline{a}}_{l}^{T} ⊗ \overline{c} = θ ) , θ = 0 , … , {2}^{m} - 1$$

adds up to 1; the second step of the equation (19) utilizes an equal probability property of the ICBs:

$$p ( {a}_{l}^{T} ⊗ c = θ ) = \frac{1}{{2}^{m}} , θ = 0 , … , {2}^{m} - 1 ;$$

soft decision information, as a computation result of the a posteriori probability of the ICBs, is forwarded to a decoder of the channel-coding for decoding, so as to obtain a decision of the ICBs of the multiple data stream; and

f) complexity

the complexity of the ICB soft decision detection of the present invention comes mainly from the computation of the likelihood function in the equations (18) and (17), and the order of magnitude of the complexity depends on the number of integer values that can be obtained from θ̅=āₗ^{T}c̅; since the maximum value of āₗ^{T}c̅ is

$${\sum }_{i : {a}_{l , i} > 0} {a}_{l , i} ( {2}^{m} - 1 )$$

and the minimum value is

$${\sum }_{i : {a}_{l , i} < 0} {a}_{l , i} ( {2}^{m} - 1 ) ,$$

there is:

$$\overline{θ} ∈ \{ {\sum }_{i : {a}_{l , i} < 0} {a}_{l , i} ( {2}^{m} - 1 ) , … , {\sum }_{i : {a}_{l , i} > 0} {a}_{l , i} ( {2}^{m} - 1 ) \} \qquad ( 65 )$$

then, the number of integer values that can be obtained from θ̅ is ω_{H}(aₗ)(2^{m}−1)+1; in other words, the likelihood function (18) needs to calculate ω_{H}(aₗ)(2^{m}−1)+1 probability values (17); the complexity of the ICB soft decision detection of the present invention is of the order of O(ω_{H}(aₗ)(2^{m}−1)+1), which is much lower than the O(2^{mω(}^{ₗ}⁾) level for direct executing the equation (12).

### Embodiment 2

The present invention further provides an application of the soft decision detection method in a lattice-code multiple-access system, comprising steps of:

a) performing channel-coding and modulation

in practice, for m=1, namely binary coding and BPSK, LDPC code or polar code of the 5G NR standard is used; for m=2, 3, . . . , and 2^{m}-PAM modulation, it is suggested to use 2^{m}-ary integer ring LDPC code or irregular repeat accumulate (IRA) code, which ensures that the coded modulation belongs to the lattice code, thereby satisfying properties of lattice codes, as well as approaching the capacity limit of BER performance.

b) receiving the signal

2^{m}-ary linear codes (ring codes) have a “superposition property”, which means after the superposition of integer multiples of K usable codewords, the modulo of 2^{m} is still a usable codeword; namely

$$mod ( {\sum }_{i = 1}^{K} {a}_{i} {c}_{i} , {2}^{m} ) \qquad ( 66 )$$

still an available codeword in the codebook;

applying the superposition property of the codewords to obtain

$${v}_{l} = mod ( {\sum }_{i = 1}^{K} {a}_{l , i} G ⊗ {b}_{i} , q ) = G ⊗ mod ( {\sum }_{i = 1}^{K} {a}_{l , i} {b}_{i} , {2}^{m} ) = G ⊗ {u}_{l} . \qquad ( 67 )$$

which means codeword ICB is linked to message ICB by a channel-coding generation matrix G; based on this property, decoding can be realized by the following steps:

1. the soft decision detector calculates the symbol-by-symbol a posteriori probabilities (APPs) of the codeword ICBs, i.e., p(vₗ[t]|y[t]), t=1, . . . , n; wherein vₗ[t] and y[t] denote the t-th column of vₗ and Y; see step c) below; and

2. the decoder takes the APP of the codeword ICB as input to perform a decoding operation, and outputs a decision uₗ about the message ICB; see step d) below;

c) performing soft decision detection of the ICBs (same as the step 4 of the embodiment 1, not repeated here)

d) decoding the channel-coding

for m=1, namely binary coding and BPSK, iterative belief propagation (BP) decoding is used along with the LDPC coding, and serial list decoding is used along with the polar coding; for m=2, 3, . . . , namely using 2^{m}-ary LDPC or IRA ring code together with 2^{m}-PAM modulation, then 2^{m}-ary iterative belief propagation (BP) decoding is used; the computational complexity of 2^{m}-ary check nodes can be further reduced by FFT/IFFT variations;

e) recovering user data

performing the soft decision detection and decoding operations in parallel for the K ICBs to generate:

$$U = {[ {u}_{1} , … , {u}_{K} ]}^{T} = A ⊗ B \qquad ( 27 )$$

since A is full-ranked on Z₂_{^{m}}, there exists a unique inverse matrix A⁻¹:A⁻¹⊗A=I; using an operation:

$${A}^{- 1} ⊗ U = B \qquad ( 28 )$$

for recovering all user message data B; and

f) performing simulation and performance evaluation

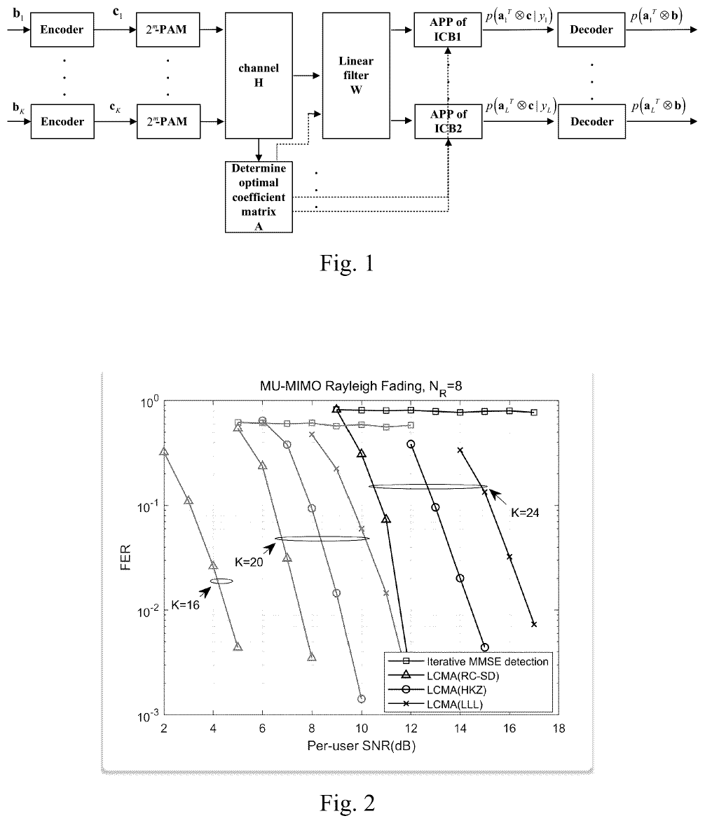

FIG. 2 shows FER performance when using ICB soft decision detection and decoding in an uplink lattice-code multiple-access system; wherein rate 1/2 binary LDPC code of length 480 with BPSK modulation are adopted, and per-user spectral efficiency is 1/2 bit/symbol; the number of receiver antennas is N=8, the number of users is K=16, 20, 24, and the total spectral efficiency is 8, 10, 12 bits/symbol, respectively; compared with the baseline iterative MMSE detection and decoding method, the method of the present invention can support a higher number of users with lower FER; we see that the performance of the system is highly dependent on the choice of the coefficient matrix A; specifically, for solving A, the rate-constrained spherical decoding (RC-SD) achieves better FER performance than the LLL algorithm.

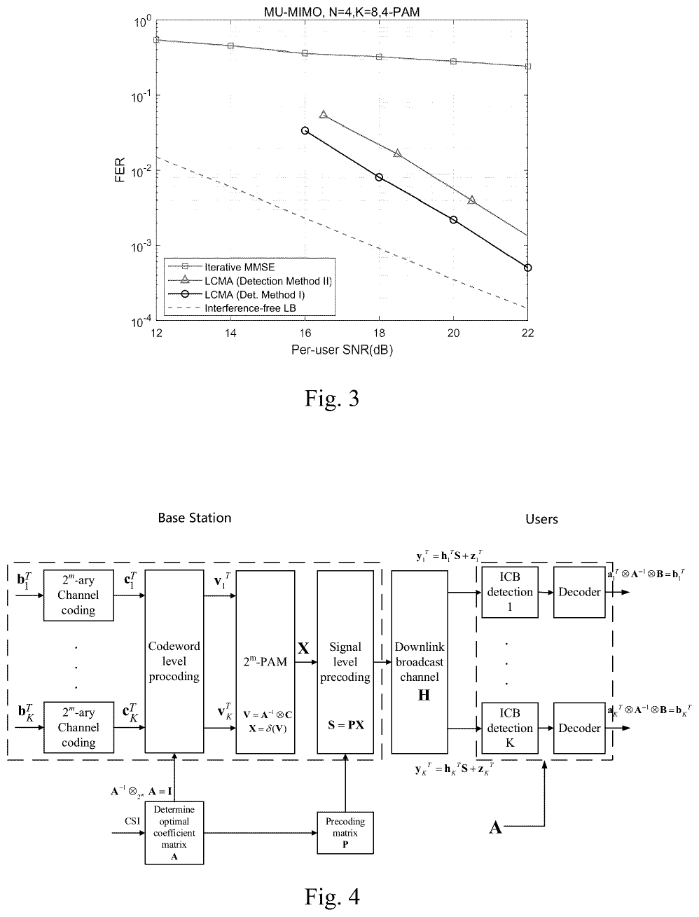

FIG. 3 shows FER performance when using the ICB soft decision detection and decoding in the uplink lattice-code multiple-access (LCMA) system, wherein receiver antenna number is N=4 and user number is K=8; 4-ary coding with 4-PAM modulation is used, and channel-coding adopts 4-ary LDPC code with code length k=256, code rate 1/2, and per-user spectral efficiency of 1 bit/symbol; the total spectral efficiency is 8 bits/symbol; it can be seen that the performance of this method can support higher number of users with lower FER than the baseline iterative MMSE detection and decoding method; the gap between the performance of the method of the present invention and an FER lower bound under an assumed interference-free condition is about 2.6 dB; the ICB soft decision mentioned in the step 4 shows a certain performance loss when using the equation (17) (detection method II) and using the equation (63) (detection method II); although the method II eliminates the calculation of conditional mean and conditional variance, but the performance loss is non-negligible.

### Embodiment 3

The present invention further provides a lattice-based downlink MIMO broadcasting (LBC) system using the method for the soft decision detection of the multiple data stream ICBs, wherein:

the lattice-based downlink MIMO broadcasting (LBC) system utilizes the above ICB soft decision detection method; considering the base station needs to deliver respective data streams to K users, the base station is equipped with N antennas, and the users are equipped with a single antenna, but it can be easily extended to multiple antennas at the user terminals; with OFDM modulation, there is no inter-symbol interference; the channel state information at the base station is known; the LBC system and processing method of the present invention are applicable to flat channel as well as frequency-selective channel models, and the frequency-selective channel model is described here, wherein if an interval between t′ and t is greater than a coherent bandwidth, then H[t]≠H[t′].

A block diagram of the system is shown in FIG. 4. The system comprises: a channel encoder, a codeword level precoder, a PAM modulator, a signal level precoder, an integer-combination soft decision detector, and a decoder; wherein the channel encoder, the codeword precoder, the PAM modulator, and the signal level precoder are arranged at the base station; and the integer-combination soft decision detector and the decoder are arranged at the user terminal; wherein:

a) the channel encoder encodes individual message sequences

a message data sequence of user i is represented by a row vector bᵢ^{T}, i=1, 2, . . . K; wherein k is the length of the message data sequence; for multi-element bᵢ^{T}, the channel-coding adopts cᵢ=G⊗bᵢ, i=1, 2, . . . , K;

bᵢ^{T} is modified as a binary data stream, which is encoded with binary LDPC or polarization codes; an output codeword sequence is mapped into elements of {0, 1, . . . , 2^{m}−1} using “m to 1” mapping, which is denoted as cᵢ^{T}∈{0, 1, . . . , 2^{m}−1}ⁿ, i=1, 2, . . . K; a column vector c[t]=[c₁[t], . . . , c_{K}[t]]^{T} indicates the t-th symbol position of all K streams of codeword sequences;

b) the codeword level precoder precodes the column vector c[t] obtained by the channel encoder at a codeword level to obtain a precoded codeword sequence

the base station of the LBC system uses the method for the soft decision detection of the ICBs of multiple data streams to select K linearly independent integer coefficient vectors aₗ^{T}[t], . . . , a_{K}^{T}[t] for each signal sequence within a coherent bandwidth based on channel state information H[t] at the receiver, so that an integer coefficient matrix is A[t]=[a₁[t], . . . , a_{K}[t]]^{T}; since a frequency-selective channel is considered, if an interval between t′ and t is greater than the coherent bandwidth, then H[t]≠H[t′], so A[t]≠A[t′]; the LBC system requires A[t] to be full-ranked on Z₂_{^{m}} and there exists a unique inverse matrix A[t]⁻¹:A[t]⁻¹⊗A[t]=I;

in the LBC system, A⁻¹[t] is used to precode c[t] at the codeword level, so as to obtain the precoded codeword sequence:

$$v [ t ] = {A}^{- 1} [ t ] ⊗ c [ t ] , t = 1 , … , n \qquad ( 29 )$$

wherein v[t]=[v₁[t], . . . , v_{K}[t]]^{T}; and vₗ^{T}=[vₗ[1], . . . , vₗ[n]], l=1, . . . , K, which is the l-th precoded codeword sequence;

c) the PAM modulator:

a symbol sequence xₗ^{T}=[xₗ[1], . . . , xₗ[n]], l=1, . . . , K is mapped one by one to 2^{m}-PAM by the equation (1); a column vector x[t]=[x₁[t], . . . , x_{K}[t]]^{T} denotes the t-th symbol position of all K symbol sequences;

d) the signal level precoder precodes the precoded codeword sequence at a signal level to produce a transmission signal

the LBC system uses a regularized integer-forcing precoding matrix for signal level precoding, and the precoding matrix is:

$$P [ t ] = {H [ t ]}^{T} {( \frac{K}{ρ} I + H [ t ] {H [ t ]}^{T} )}^{- 1} A [ t ] \qquad ( 30 )$$

the base station produces the transmission signal after precoding, which is denoted as:

$$s [ t ] = P [ t ] x [ t ] , t = 1 , … , n \qquad ( 31 )$$

the transmission signal is transmitted via multiple antennas at the base station;

e) the ICB soft decision detector calculates the a posteriori probability of an ICB of codeword sequences v[t] precoded by the codeword precoder in a symbol-by-symbol form

signals received by K users are denoted as:

$$y [ t ] = H [ t ] s [ t ] + z [ t ] = H [ t ] P [ t ] x [ t ] + z [ t ] , t = 1 , … , n \qquad ( 32 )$$

wherein the i-th element yᵢ[t] of the column vector y[t] is the signal received by the i-th user at moment t; yᵢ^{T}=[yᵢ[1], . . . , yᵢ[n]], i=1, . . . , K denotes the signal sequence received by the i-th user;

a receiver of the user i is informed of a coefficient vector aᵢ^{T}[t]; the posterior probability of the ICBs about (precoded codeword) v[t] is computed symbol-by-symbol:

$$p ( {{a}_{i}}^{T} [ t ] ⊗ v [ t ] = θ \vert {y}_{i} [ t ] ) , θ = 0 , … , {2}^{m} - 1 \qquad ( 33 )$$

because of the codeword precoding with the equation (29):

$${a}_{i}^{T} [ t ] ⊗ v [ t ] = {a}_{i}^{T} [ t ] ⊗ {A}^{- 1} [ t ] ⊗ c [ t ] = {c}_{i} [ t ] , i = 1 , … , K \qquad ( 34 )$$

therefore, the calculated a posteriori probability of the ICB of v[t] is the a posteriori probability of the codeword cᵢ[t]:

$$p ( {c}_{i} [ t ] = θ \vert {y}_{i} [ t ] ) = p ( {a}_{i}^{T} [ t ] ⊗ y [ t ] = θ \vert {y}_{i} [ t ] ) , i = 1 , … , K \qquad ( 35 )$$

f) the decoder performs hard decision on the a posteriori probability obtained by the ICB soft decision detector, so as to obtain a desired decoding result of the message sequence

the a posteriori probability is forwarded to the decoder of channel-coding, and each user performs one decoding, a decoder output of the user i is:

$$p ( {b}_{i} [ t ] ) , t = 1 , … , k \qquad ( 36 )$$

the desired decoding result of the message sequence is obtained by the hard decision; and

g) simulation and performance evaluation

simulation is carried out with considering different modulations, number of users, and number of antennas; bit error rate (BER) results are recorded, and different detection methods are compared with each other, including conventional MMSE and ZF baseline precoding.

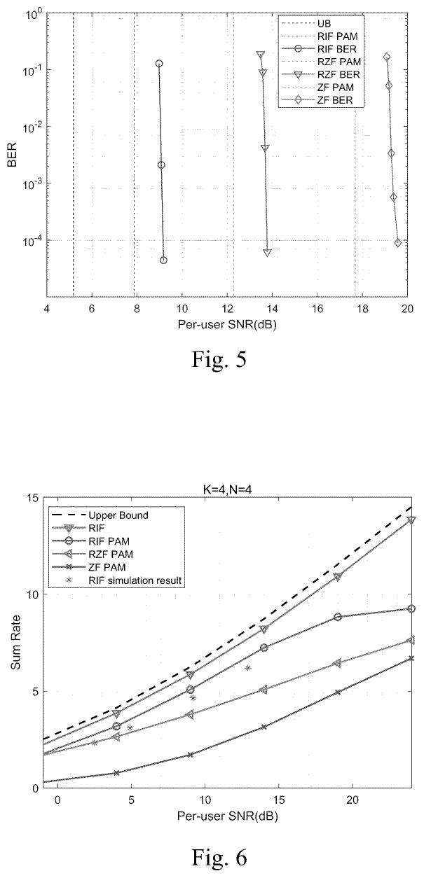

FIGS. 5 and 6 show bit error rate (BER) performance of the ICB soft decision and the lattice-based downlink MIMO broadcasting system of the present invention under a slow fading channel (flat channel), which is compared with theoretical boundary and baseline schemes. The number of receiver antennas is N=4 and the number of users is K=4; 5-ary IRA coding and 5-PAM modulation are used, and at least 500 channel realizations are performed for each SNR during the simulation, with code length of 50000, and average code rate of 1/2. It is seen that the performance of this system has better BER performance compared with the baseline RZF and ZF precoding methods. A gap between the performance of the method of the present invention and 5-PAM limit rate is about 1.3 dB, and this gap originates partly from the gap between the coding performance and the Shannon limit, and partly from the fact that not all channel resources are fully utilized during actual coding under the slow fading channel since the rate of available channel for coding are not continuous.

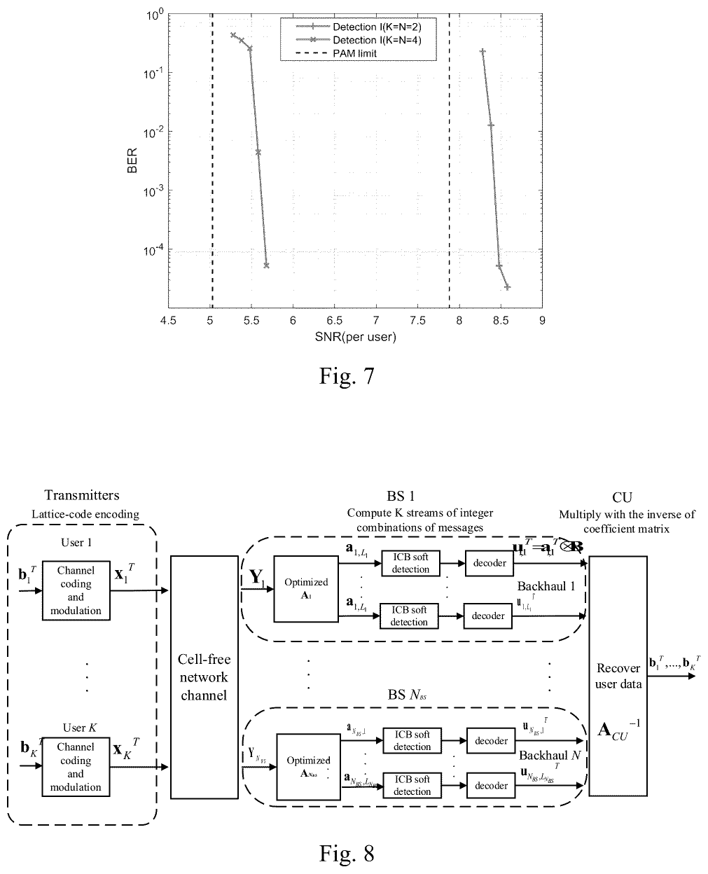

FIG. 7 illustrates BER performance of the present invention under a fast fading channel (frequency-selective channel). The performance by using the equation (13) and that by using the equation (17) are compared. It can be seen that when using the ICB soft decision detection of the present invention, the gap between the theoretical bounds of the lattice-based MIMO broadcasting system and the RIF is less than 1 dB;

### Embodiment 4

The present invention also provides a lattice-based cell-free MIMO system for performing the soft decision detection of the integer-combination, comprising:

a K-user cell-free MIMO network model with a total of N_{BS} distributed units DU, wherein each DU is connected to a central unit CU via a backhaul link BH; the capacity of the BH link is constrained to be of the same order of magnitude as that of an air interface; each user is considered to have a single antenna, and the base station receiver has N antennas.

A block diagram of the described cell-free MIMO system is shown in FIG. 8, wherein the lattice-based cell-free MIMO system further comprises: a channel-coding and modulation device, a cell-free network channel, an integer-combination soft decision detector, a decoder of channel-coding, and a user data decoder for CU;

a) the channel-coding and modulation device encodes each sequence of user message data

a 2^{m}-ary message data sequence of user i is represented by a row vector bᵢ^{T}∈{0, 1, . . . , 2^{m}−1}^{k}, i=1, 2, . . . K; wherein k is the length of the message data sequence; message data of all K users is represented by a matrix B=[b₁, . . . , b_{K}]^{T} with size of K×k; the message data sequence of each user is encoded using a 2^{m}-ary ring code: cᵢ=G⊗bᵢ, i=1, 2, . . . , K; then 2^{m}-PAM symbols are generated with the equation (1), and all users transmit in the same band at the same time;

b) the cell-free network channel receives signals from each distributed base station

the signal received by the receiver at the base station j is the same as that of the equation (2), which is denoted as:

$${Y}_{j} = {\sum }_{i = 1}^{K} \sqrt{ρ} {h}_{j , i} {x}_{i}^{T} + {Z}_{j} = \sqrt{ρ} {H}_{j} X + {Z}_{j} , j = 1 , … , {N}_{BS} \qquad ( 37 )$$

the base station j is designed to generate Lⱼ ICBs about the K streams of messages B=[b₁, . . . , b_{K}]^{T}, and Lⱼ is required to be as large as possible without exceeding the BH capacity limit; according to channel state information Hⱼ at the receiver, the base station selects Lⱼ linearly independent integer coefficient vectors a_{j,1}^{T}, . . . , a_{j,L}_{ⱼ}^{T}, and Aⱼ=[a_{j,1}, . . . , a_{j,K}] is the integer coefficient matrix chosen by the base station j;

c) the ICB soft decision detector calculates the a posteriori probability of an ICB of the K data streams encoded by channel-coding in a symbol-by-symbol form

the base station j uses ICB soft decision and the ICB soft decision to compute the a posteriori probability of the l-th ICB symbol-by-symbol, so as to obtain the a posteriori probability of the ICB of the K data streams encoded by channel-coding:

$$p ( {a}_{j , l}^{T} ⊗ c [ t ] = θ \vert {y}_{j} [ t ] ) = \frac{1}{{2}^{m}} , θ = 0 , … , {2}^{m} - 1 , t = 1 , … , n \qquad ( 38 )$$

then the a posteriori probability is forwarded to the decoder of the 2^{m}-ary channel-coding;

d) the decoder of channel-coding decodes and outputs the a posteriori probability

decoder output:

$$p ( {a}_{j , l}^{T} ⊗ b [ t ] = θ ) , θ = 0 , … , {2}^{m} - 1 , t = 1 , … , k \qquad ( 39 )$$

decision:

$${\hat{u}}_{j , l} [ t ] = {arg max}_{θ} p ( {a}_{j , l}^{T} ⊗ b [ t ] = θ ) \qquad ( 40 )$$

if the decision is correct, the l-th ICB u_{j,l}^{T}=[u_{j,l}[1], . . . , u_{j,l}[k]] is obtained;

e) the user data decoder for CU generates a decision for message ICBs

the soft decision detection and decoding operations of Lⱼ ICB of the base station j are carried out in parallel to obtain Uⱼ=[u_{j,1}, . . . , u_{j,L}_{ⱼ}]^{T}=Aⱼ⊗B, which is then forwarded to the CU through the BH;

meanwhile, the soft decision and decoding operations of other base stations generate U₁, . . . , U_{N}_{_{BS}}; the CU collects all the ICBs;

$$U = {[ {U}_{1}^{T} , … , {U}_{{N}_{BS}}^{T} ]}^{T} = {A}_{CU} ⊗ B \qquad ( 41 )$$

if A_{CU}=[A₁^{T}, . . . , A_{N}_{_{BS}}^{T}]^{T} is full-ranked on Z₂_{^{m}}, there exists a unique inverse matrix A_{CU}⁻¹:A_{CU}⁻¹⊗A_{CU}=I, and the CU uses:

$${A}_{CU}^{- 1} ⊗ U = B \qquad ( 42 )$$

to recover all user message data B;

the total backhaul link BH usage of the system is

$$\frac{k m}{n} {\sum }_{j = 1}^{{N}_{BS}} {L}_{j}$$

bits/symbol, which is of the same order of magnitude as the capacity of the air interface; and

f) simulation and performance evaluation

the present invention considers different number of distributed base stations, different number of users and antennas, and different code rates for simulation, wherein the frame error rate (FER) results are recorded and compared with those of the baseline schemes; with the ICB soft decision detection and decoding of the present invention, the performance of the cell-free MIMO scheme is significantly better than the baseline scheme, and the BH utilization rate is higher.

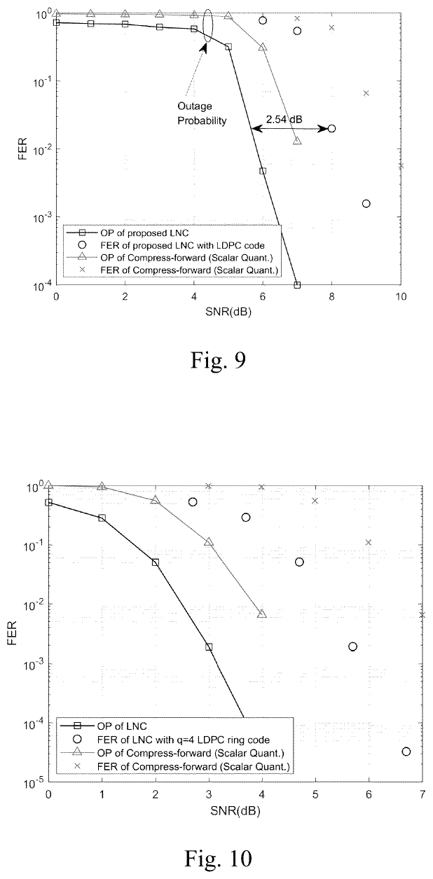

FIG. 9 illustrates FER performance of the uplink cell-free MIMO system, wherein there are 4 DUs, each with N=8 antennas, and K=24 users. Binary coding with BPSK modulation is used, and channel-coding adopts rate 1/2 length 480 LDPC code of 5G NR standard, and the per-user spectral efficiency is 1/2 bits/symbol. The baseline scheme employs compress-forward, which considers vector quantization and scalar quantization. It can be seen that the cell-free MIMO scheme of the present invention has better FER performance with the same BH consumption.

FIG. 10 illustrates FER performance with 4 DUs, each with N=8 antennas, and K=12 users, wherein m=2, which means quadratic LDPC coding with 4-PAM modulation is used, and the channel-coding adopts rate 1/2 length 256 4-ary LDPC code, and per-user spectral efficiency of 1 bit/symbol. Similarly, the cell-free MIMO scheme of the present invention has better FER performance with the same BH consumption.

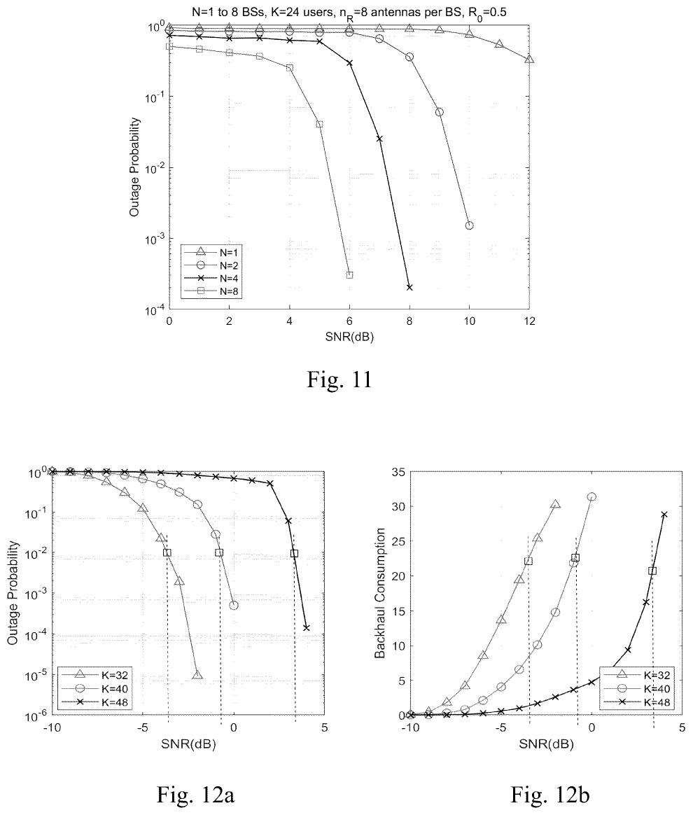

FIG. 11 illustrates performance of the uplink cell-free MIMO system, wherein there are 1, 2, 4, 8 DUs, each with N=8 antennas, and K=24 users; and m=1, which means binary coding with BPSK modulation is used, and channel-coding adopts rate 1/2 length 480 LDPC code of 5G NR standard; and the per-user spectral efficiency is 1/2 bits/symbol. It can be seen that the FER performance of the system improves with the increase in the number of DUs, wherein the BH consumption per single DU decreases with the increase in the number of DUs.

FIGS. 12a and 12b illustrate performance of a cell-free large-scale MIMO system, wherein there are 4 DUs, each with N=32 antennas, and K=32, 40, 48 users; and m=2, which means the quadratic coding with 4-PAM modulation is used with a per-user spectral efficiency of 1 bit/symbol. FIG. 12a shows outage probability performance and FIG. 12b shows BH consumption; it can be seen that the transmission rate and BH consumption are of the same order of magnitude.

What is claimed is:

1. A method for soft decision detection of multiple data stream integer-combinations, comprising steps of:
step 1: sending a signal
considering K streams of messages, denoting by row vectors b₁^{T}, . . . , b_{K}^{T}; denoting an i-th data stream after channel-coding with a row vector cᵢ^{T}, i=1, 2, . . . , K, wherein a data stream length is n; denoting a t-th symbol position of cᵢ^{T} with cᵢ[t], t=1, . . . , n; and denoting a t-th symbol position of all the K data streams with a column vector c[t]=[c₁[t], . . . , c_{K}[t]]^{T};
considering 2^{m}-ary channel-coding, m=1, 2, . . . , then cᵢ[t]∈{0, . . . , 2^{m}−1}, wherein elements of cᵢ[t] are nonnegative integers no greater than 2^{m}−1; mapping a sequence of channel-coded data streams symbol-by-symbol into a 2^{m}-PAM modulated signal sequence:
$${x}_{i}^{T} = \frac{1}{γ} ( {c}_{i}^{T} - \frac{{2}^{m} - 1}{2} ) ∈ \frac{1}{γ} {\{ \frac{1 - {2}^{m}}{2} , … , \frac{{2}^{m} - 1}{2} \}}^{n} , i = 1 , … , K , \qquad ( 1 )$$
wherein γ is a normalization factor ensuring an average energy of the sequence xᵢ^{T} is 1; elements of xᵢ^{T} are all integers divided by γ; all K streams of signals are transmitted simultaneously;
for a complex model, adopting two independent codes and modulations, and transmitting in both in-phase and quadrature parts to form 2^{2m}-QAM modulation of I/Q;
step 2: receiving the signal
considering a spatial dimension of received signals at a receiver as N;
for a real-valued model, denoting the received signal as:
$$Y = {\sum }_{i = 1}^{K} \sqrt{ρ} {h}_{i} {x}_{i}^{T} + Z = \sqrt{ρ} HX + Z \qquad ( 2 )$$
wherein hᵢ denotes a channel vector of N observations from an i-th stream signal to the receiver; H=[h₁, . . . , h_{K}] denotes a channel matrix, containing the channel vectors corresponding to all stream signals; a matrix X=[x₁, . . . , x_{K}] denotes a sequence of all the K streams of signals, wherein an i-th row represents an i-th stream signal; Z denotes an additive white Gaussian noise matrix, whose elements are independently and identically distributed zero-mean unit-variance Gaussian noises; ρ denotes an average energy of the stream signals, which is equivalent to a signal-to-noise ratio; Y=[y[1], . . . , y[n]], y[t] is a received signal vector for a t-th symbol position;
wherein a complex-valued model is represented by a real-valued model of doubled dimension:
$$[ \begin{matrix}{Y}^{Re} \\ {Y}^{Im}\end{matrix} ] = \sqrt{ρ} [ \begin{matrix}{H}^{Re} & - {H}^{Im} \\ {H}^{Im} & {H}^{Re}\end{matrix} ] [ \begin{matrix}{X}^{Re} \\ {X}^{Im}\end{matrix} ] + [ \begin{matrix}{Z}^{Re} \\ {Z}^{Im}\end{matrix} ] \qquad ( 3 )$$
step 3: defining the multiple data stream integer-combinations
considering an integer coefficient vector a^{T}∈Z^{K} with a length K; denoting an integer-combination on Z₂_{^{m}} with respect to c[t] as:
$${a}^{T} ⊗ c [ t ] = mod ( {a}^{T} c [ t ] , {2}^{m} ) , t = 1 , … , n \qquad ( 4 )$$
wherein mod (□, 2^{m}) means a mod 2^{m} operation, and a range of values of the integer-combination is a^{T}⊗c[t]∈{0, . . . , 2^{m}−1};
in general, L integer-combinations are denoted as:
$${a}_{l}^{T} ⊗ c [ t ] , l = 1 , … , L , t = 1 , … , n , \qquad ( 5 )$$
wherein aₗ^{T}∈Z^{K} denotes an integer coefficient vector corresponding to an l-th integer-combination; and
step 4: computing a posterior probability for the multiple data stream integer-combinations
based on the received signal Y=[y[1], . . . , y[n]], using the receiver to calculate the L integer-combinations;
recalling the range of values of the integer-combination a^{T}⊗c[t]=θ,θ∈{0, . . . , 2^{m}−1}; and computing the posterior probability of the integer-combinations as:
$$y \to p ( {{a}_{l}}^{T} ⊗ c = θ \vert y ) , θ ∈ \{ 0 , … , {2}^{m} - 1 \} , \qquad ( 6 )$$
wherein l=1, . . . , L;
for L integer coefficient vectors a₁^{T}, . . . , a_{L}^{T}, operating the equation (6) as follows:
a) linear filter
defining W as a linear filtering matrix with a size of L×N, which only contains real elements; defining wₗ^{T} as an l-th row of W and normalizing as ∥wₗ∥²=1; filtering to form L signals:
$$\begin{matrix}{\tilde{y}}_{l} = {w}_{l}^{T} y = \sqrt{ρ} {w}_{l}^{T} {\sum }_{i = 1}^{K} {h}_{i} {x}_{i} + {\tilde{z}}_{l} \\ = {\sum }_{i = 1}^{K} \sqrt{ρ} {ψ}_{l , i} {x}_{i} + {\tilde{z}}_{l} , l = 1 , … , L\end{matrix} , \qquad ( 7 )$$
wherein ψ_{l,i}=wₗ^{T}hᵢ is a real-valued equivalent gain, and a variance of a noise term \tilde{z}ₗ is 1;
b) signal representation
in order to calculate the posterior probability of aₗ^{T}⊗c, equivalently representing the received signals defined by the equation (7) as follows; using Iₗ□{i:a_{l,i}≠0} to collect positions of non-zero terms of aₗ, wherein Iₗ^{c} denotes a complement, and ω(aₗ)□|Iₗ| denotes a quantity of the non-zero terms of aₗ; then the equation (7) is expressed as:
$${\tilde{y}}_{l} = {\sum }_{i ∈ {I}_{l}} \sqrt{ρ} {ψ}_{l , i} {x}_{i} + {\sum }_{i ∈ {I}_{l}^{c}} \sqrt{ρ} {ψ}_{l , i} {x}_{i} + {\tilde{z}}_{l} = {\sum }_{i ∈ {I}_{l}} \sqrt{ρ} {ψ}_{l , i} {x}_{i} + {ξ}_{l} . ; \qquad ( 8 )$$
wherein
$${\sum }_{i ∈ {I}_{l}} \sqrt{ρ} {ψ}_{l , i} {x}_{i}$$
denotes superposition of signals of ω(aₗ) users with non-zero coefficients of aₗ, which is a useful signal part for computation of the integer-combinations;
$${\sum }_{i ∈ {I}_{l}^{c}} \sqrt{ρ} {ψ}_{l , i} {x}_{i}$$
also contains signals of remaining K−ω(aₗ) users, which corresponds to zero coefficients of aₗ, and is not relevant to the integer-combinations;
$${ξ}_{l} = {\sum }_{i ∈ {I}_{l}^{c}} \sqrt{ρ} {ψ}_{l , i} {x}_{i} + {\tilde{z}}_{l}$$
is considered as equivalent noise, which is not relevant to the useful signal part; for a sufficiently large K, |Iₗ^{c}| is also sufficiently large; according to central limit theorem, the equivalent noise ξₗ follows a Gaussian distribution, with zero mean and variance
$${\tilde{σ}}_{l}^{2} = {γ}^{2} ( ρ {\sum }_{i ∈ {I}_{l}^{c}} {ψ}_{l , i}^{2} + 1 ) ;$$
using a bijection between xᵢ and cᵢ in the equation (1), which is
$${x}_{i} = \frac{1}{γ} ( {c}_{i} - \frac{{2}^{m} - 1}{2} ) ,$$
to further simplify the equation (8) as:
$${\tilde{y}}_{l} = \frac{\sqrt{ρ}}{γ} {\sum }_{i ∈ {I}_{l}} {ψ}_{l , i} {c}_{i} + {ξ}_{l} - {φ}_{l} \qquad ( 9 )$$
wherein
$${φ}_{l} = \frac{\sqrt{ρ}}{γ} \frac{{2}^{m} - 1}{2} {\sum }_{i ∈ {I}_{l}} {ψ}_{l , i}$$
is not relevant to the signals, and is compensated by y̅ₗ=\tilde{y}ₗ+φₗ to obtain:
$${\overline{y}}_{l} = \frac{\sqrt{ρ}}{γ} {\sum }_{i ∈ {I}_{l}} {ψ}_{l , i} {c}_{i} + {ξ}_{l} \qquad ( 10 )$$
then, only signals of the users corresponding to non-zero elements in aₗ exist in a signal portion of the equation (1); and computation of the posterior probability of the integer-combinations is denoted as:
$${\overline{y}}_{l} \to p ( {{a}_{l}}^{T} ⊗ c = θ \vert {\overline{y}}_{l} ) , θ ∈ \{ 0 , … , {2}^{m} - 1 \} , \qquad ( 11 )$$
wherein l=1, . . . , L;
c) exact computation of a likelihood function for the integer-combinations
to find the posterior probability in the equation (11), the likelihood function p(y̅ₗ|aₗ^{T}⊗c=θ) is necessary, which is calculated as follows:
a vector āₗ contains only non-zero elements of āₗ and a vector c̅ contains only portions of c that corresponds to the non-zero elements of aₗ; lengths of āₗ and c̅ are ω(aₗ)=|Iₗ| a total probability equation is:
$$p ( {\overline{y}}_{l} \vert {{a}_{l}}^{T} ⊗ c = θ ) = p ( {\overline{y}}_{l} \vert {{\overline{a}}_{l}}^{T} ⊗ \overline{c} = θ ) = {\sum }_{\overline{c} : {{\overline{a}}_{l}}^{T} ⊗ \overline{c} = θ} p ( {\overline{y}}_{l} \vert \overline{c} ) p ( \overline{c} \vert {{\overline{a}}_{l}}^{T} ⊗ \overline{c} = θ ) \qquad ( 12 )$$
then the equation (10) is modified as:
$$p ( {\overline{y}}_{l} \vert \overline{c} ) = \frac{1}{\sqrt{2 π}} exp ( \frac{- {\vert {\overline{y}}_{l} - \frac{\sqrt{ρ}}{γ} {\sum }_{i ∈ {I}_{l}} {ψ}_{l , i} {c}_{i} \vert}^{2}}{2 {\tilde{σ}}_{l}^{2}} ) \qquad ( 13 )$$
d) computation of a low-complexity likelihood function based on Gaussian approximation
considering a “many-to-one” mapping between āₗ^{T}c̅ and āₗ^{T}⊗c̅, a likelihood function p(y̅ₗ|āₗ^{T}c̅=θ̅) for āₗ^{T}c̅ is computed first, which is then transformed into p(y̅ₗ|āₗ^{T}⊗c̅=θ);
using a set Ωₗ(θ̅)={c̅:āₗ^{T}c̅=θ̅} to collect candidate sequences of c̅ which satisfy āₗ^{T}c̅=θ̅; wherein for a given āₗ^{T}c̅=θ̅, a conditional mean of y̅ₗ is:
$${μ}_{l} ( \overline{θ} ) = {E}_{c} ( {\overline{y}}_{l} \vert {\overline{a}}_{l}^{T} c = \overline{θ} ) = {E}_{c} ( \frac{\sqrt{ρ}}{γ} {\sum }_{i ∈ {I}_{l}} {ψ}_{l , i} {c}_{i} + {ξ}_{l} \vert {\overline{a}}_{l}^{T} \overline{c} = \overline{θ} ) = \frac{1}{\vert {Ω}_{l} ( \overline{θ} ) \vert} {\sum }_{\overline{c} ∈ {Ω}_{l} ( \overline{θ} )} {\sum }_{i ∈ {I}_{l}} \frac{\sqrt{ρ}}{γ} {ψ}_{l , i} {c}_{i} \qquad ( 14 )$$
a conditional variance of y̅ₗ is:
$${σ}_{l}^{2} ( \overline{θ} ) = {E}_{c} ( {\vert {\sum }_{i ∈ {I}_{l}} \frac{\sqrt{ρ}}{γ} {ψ}_{l , i} {c}_{i} + {ξ}_{l} - {μ}_{l} ( \overline{θ} ) \vert}^{2} ) = {{E}_{c} ( {\sum }_{i ∈ {I}_{l}} \frac{\sqrt{ρ}}{γ} {ψ}_{l , i} {c}_{i} )}^{2} - {μ}_{l}^{2} ( \overline{θ} ) + {\tilde{σ}}_{l}^{2} = \frac{1}{\vert {Ω}_{l} ( \overline{θ} ) \vert} {\sum }_{c ∈ {Ω}_{l} ( \overline{θ} )} {( {\sum }_{i ∈ {I}_{l}} \frac{\sqrt{ρ}}{γ} {ψ}_{l , i} {c}_{i} )}^{2} - {μ}_{l}^{2} ( \overline{θ} ) + {\tilde{σ}}_{l}^{2} \qquad ( 15 )$$
thus, if the transmitted signal satisfies āₗ^{T}c̅=θ̅, the received signal is represented as:
$${\overline{y}}_{l} = {μ}_{l} ( \overline{θ} ) + {\overline{z}}_{l} ( \overline{θ} ) \qquad ( 16 )$$
when K is sufficiently large, for a given θ̅, y̅ₗ is approximated as a Gaussian distribution with a mean μₗ(θ̅) and a variance σₗ²(θ̅); thus, the likelihood function is expressed as:
$$p ( {\overline{y}}_{l} \vert {\overline{a}}_{l}^{T} \overline{c} = \overline{θ} ) \approx \frac{1}{\sqrt{2 π} {σ}_{l} ( \overline{θ} )} exp ( - \frac{{( {\overline{y}}_{l} - {μ}_{l} ( \overline{θ} ) )}^{2}}{2 {σ}_{l}^{2} ( \overline{θ} )} ) \qquad ( 17 )$$
then using the total probability equation to obtain the likelihood function for the integer-combinations:
$$p ( {\overline{y}}_{l} \vert {\overline{a}}_{l}^{T} ⊗ \overline{c} = θ ) = {\sum }_{\overline{θ} : mod ( \overline{θ} , {2}^{m} ) = θ} p ( {\overline{y}}_{l} \vert {\overline{a}}_{l}^{T} \overline{c} = \overline{θ} ) p ( {\overline{a}}_{l}^{T} \overline{c} = \overline{θ} \vert {\overline{a}}_{l}^{T} ⊗ \overline{c} = θ ) = \frac{1}{{2}^{m}} {\sum }_{\overline{θ} : mod ( \overline{θ} , {2}^{m} ) = θ} p ( {\overline{y}}_{l} \vert {\overline{a}}_{l}^{T} \overline{c} = \overline{θ} ) p ( {\overline{a}}_{l}^{T} \overline{c} = \overline{θ} ) \qquad ( 18 )$$
e) computation of the posterior probability of the integer-combinations
based on the likelihood function (18) for the integer-combinations, computing the posterior probability of the integer-combinations with a Bayes' equation:
$$p ( {a}_{l}^{T} ⊗ c = θ \vert {\overline{y}}_{l} ) = \frac{p ( {\overline{y}}_{l} \vert {a}_{l}^{T} ⊗ c = θ ) p ( {a}_{l}^{T} ⊗ c = θ )}{p ( {\overline{y}}_{l} )} = \frac{1}{η} p ( {\overline{y}}_{l} \vert {\overline{a}}_{l}^{T} ⊗ \overline{c} = θ ) \qquad ( 19 )$$
wherein η is a normalization factor ensuring a sum of all calculated soft decision terms
$$\frac{1}{η} p ( {\overline{y}}_{l} \vert {\overline{a}}_{l}^{T} ⊗ \overline{c} = θ ) ,$$
$$θ = 0 , … , {2}^{m} - 1$$
adds up to 1; a second step of the equation (19) utilizes an equal probability property of the integer-combinations:
$$p ( {a}_{l}^{T} ⊗ c = θ ) = \frac{1}{{2}^{m}} ,$$
$$θ = 0 , … , {2}^{m} - 1 ;$$
soft decision information, as a computation result of the a posteriori probability of the integer-combinations, is forwarded to a decoder of the channel-coding for decoding, so as to obtain a decision of the integer-combinations of the multiple data stream.

2. The method, as recited in claim 1, wherein if operated in a lattice-code multiple-access system, the method further comprises steps of:
a) performing channel-coding and modulation
representing a 2^{m}-ary message data sequence of a user i by a row vector bᵢ^{T}∈{0, 1, . . . , 2^{m}−1}^{k}, i=1, 2, . . . K; wherein k is a length of the message data sequence; representing messages of all K users by a matrix B=[b₁, . . . , b_{K}]^{T} having a size of K×k; encoding the message data sequence of each user using a 2^{m}-ary ring code:
$${c}_{i} = G ⊗ {b}_{i} , \qquad ( 21 )$$
$$i = 1 , 2 , … , K$$
then generating 2^{m}-PAM symbols with the equation (1), wherein all users transmit in a same band at a same time;
b) receiving the signal
receiving the signal represented in the equation (2) by a receiver at a base station; applying a definition of the soft decision detection of the multiple data stream integer-combinations, and selecting L=K linearly independent integer coefficient vectors a₁^{T}, . . . , a_{K}^{T} by the base station according to channel state information H at the receiver; defining A=[a₁, . . . , a_{K}]^{T} as an integer coefficient matrix, which is full-ranked on Z₂_{^{m}}; and defining the integer-combinations of messages as:
$${u}_{l}^{T} ▯ {a}_{l}^{T} ⊗ B , \qquad ( 22 )$$
$$l = 1 , … , K$$
wherein the receiver computes K integer-combinations u₁, . . . , u_{K} in advance, and then recovers the messages B=[b₁, . . . , b_{K}]^{T} of all the users;
c) performing soft decision detection of the integer-combinations
for the l-th integer-combination, using the method for the soft decision detection of the integer-combinations by the receiver, thereby calculating the a posteriori probability of the integer-combination of the channel-encoded K data streams in a symbol-by-symbol form:
$$p ( {a}_{l}^{T} ⊗ c [ t ] = θ \vert y [ t ] ) = \frac{1}{{2}^{m}} , \qquad ( 23 )$$
$$θ = 0 , … , {2}^{m} - 1 , t = 1 , … , n$$
then forwarding the a posteriori probability to the decoder of the 2^{m}-ary channel-coding;
d) decoding the channel-coding
decoder output:
$$p ( {a}_{l}^{T} ⊗ b [ t ] = θ ) , \qquad ( 24 )$$
$$θ = 0 , … , {2}^{m} - 1 , t = 1 , … , k$$
decision:
$${\hat{u}}_{l} [ t ] = {arg max}_{θ} p ( {a}_{l}^{T} ⊗ b [ t ] = θ ) \qquad ( 25 )$$
if the decision is correct, then obtaining the l-th integer-combination of the K user's message:
$${u}_{l} [ t ] = {a}_{l}^{T} ⊗ b [ t ] \qquad ( 26 )$$
and uₗ^{T}=[uₗ[1], . . . , uₗ[k]]; and
e) recovering user data
performing the soft decision detection and decoding operations in parallel for the K integer-combinations to generate:
$$U = {[ {u}_{1} , … , {u}_{K} ]}^{T} = A ⊗ B \qquad ( 27 )$$
since A is full-ranked on Z₂_{^{m}}, there exists a unique inverse matrix A⁻¹: A⁻¹⊗A=I; using an operation:
$${A}^{- 1} ⊗ U = B \qquad ( 28 )$$
for recovering all user message data B.

3. A lattice-based downlink MIMO broadcasting (LBC) system using the method for the soft decision detection of the multiple data stream integer-combinations as recited in claim 1, comprising:
a channel encoder, a codeword level precoder, a PAM modulator, a signal level precoder, an integer-combination soft decision detector, and a decoder; wherein the channel encoder, the codeword precoder, the PAM modulator, and the signal level precoder are arranged at a base station; and the integer-combination soft decision detector and the decoder are arranged at a user terminal; wherein:
a) the channel encoder encodes individual message sequences
a message sequence of a user i is represented by a row vector bᵢ^{T}, i=1, 2, . . . K; wherein k is a length of the message sequence; for multi-element bᵢ^{T}, the channel-coding adopts cᵢ=G⊗bᵢ, i=1, 2, . . . , K;
bᵢ^{T} is modified as a binary data stream, which is encoded with binary LDPC or polarization codes; an output code word sequence is mapped into elements of {0, 1, . . . , 2^{m}−1} using “m to 1” mapping, which is denoted as cᵢ^{T}∈{0, 1, . . . , 2^{m}−1}ⁿ, i=1, 2, . . . K; a column vector c[t]=[c₁[t], . . . , c_{K} [t]]^{T} indicates that a t-th symbol position of all K streams of code word sequences is in a downlink system;
b) the codeword level precoder precodes the column vector c[t] obtained by the channel encoder at a codeword level to obtain a precoded codeword sequence
the base station of the LBC system uses the method for the soft decision detection of the multiple data stream integer-combinations to select K linearly independent integer coefficient vectors a₁^{Tl [t], . . . , a}_{K}^{T}[t] for each signal sequence within a coherent bandwidth based on channel state information H[t] at a receiver, so that an integer coefficient matrix is A[t]=[a₁[t], . . . , a_{K}[t]]^{T}; since a frequency-selective channel is considered, if an interval between t′ and t is greater than the coherent bandwidth, then H[t]≠H[t′], so A[t]≠A[t′]; the LBC system requires A[t] to be full-ranked on Z₂_{^{m}} and there exists a unique inverse matrix A[t]⁻¹:A[t]⁻¹⊗A[t]=I;
in the LBC system, A⁻¹[t] is used to precode c[t] at the codeword level, so as to obtain the precoded codeword sequence:
$$v [ t ] = {A}^{- 1} [ t ] ⊗ c [ t ] , t = 1 , … , n \qquad ( 29 )$$
wherein v[t]=[v₁[t], . . . , v_{K}[t]]^{T}; and vₗ^{T}=[vₗ[1], . . . , vₗ[n]], l=1, . . . , K, which is the l-th precoded code word sequence;
c) the PAM modulator:
a symbol sequence xₗ^{T}=[x_{z}[1], . . . , xₗ[n]], l=1, . . . , K is mapped one by one to 2^{m}-PAM by the equation (1); a column vector x[t]=[x₁[t], . . . , x_{K}[t]]^{T} denotes a t-th symbol position of all K symbol sequences;
d) the signal level precoder precodes the precoded code word sequence at a signal level to produce a transmission signal
the LBC system uses a regularized integer-forcing precoding matrix for signal level precoding, and the precoding matrix is:
$$P [ t ] = {H [ t ]}^{T} {( \frac{K}{ρ} I + H [ t ] {H [ t ]}^{T} )}^{- 1} A [ t ] \qquad ( 30 )$$
the base station produces the transmission signal after precoding, which is denoted as:
$$s [ t ] = P [ t ] x [ t ] , t = 1 , … , n \qquad ( 31 )$$
the transmission signal is transmitted via multiple antennas at the base station;
e) the integer-combination soft decision detector calculates an a posteriori probability of an integer-combination of a codeword sequence v[t] precoded by the codeword precoder in a symbol-by-symbol form
signals received by K users are denoted as:
$$y [ t ] = H [ t ] s [ t ] + z [ t ] = H [ t ] P [ t ] x [ t ] + z [ t ] , t = 1 , … , n \qquad ( 32 )$$
wherein an i-th element yᵢ[t] of the column vector y[t] is a signal received by an i-th user;
a receiver of the user i is informed of a coefficient vector aᵢ^{T}[t]; the posterior probability of the integer-combinations about v[t] is computed symbol-by-symbol as:
$$p ( {a}_{i}^{T} [ t ] ⊗ v [ t ] = θ \vert {y}_{i} [ t ] ) θ = 0 , … , {2}^{m} - 1 \qquad ( 33 )$$
because of the codeword precoding with the equation (29):
$${a}_{i}^{T} [ t ] ⊗ v [ t ] = {a}_{i}^{T} [ t ] ⊗ {A}^{- 1} [ t ] ⊗ c [ t ] = {c}_{i} [ t ] , i = 1 , … , K \qquad ( 34 )$$
therefore, the calculated a posteriori probability of the integer-combinations of v[t] is an a posteriori probability of the codeword cᵢ[t]:
$$p ( {c}_{i} [ t ] = θ \vert {y}_{i} [ t ] ) = p ( {a}_{i}^{T} [ t ] ⊗ v [ t ] = θ \vert {y}_{i} [ t ] ) i = 1 , … , K \qquad ( 35 )$$
f) the decoder performs hard decision on the a posteriori probability obtained by the integer-combination soft decision detector, so as to obtain a desired decoding result of the message sequence
the a posteriori probability is forwarded to the decoder of channel-coding, and each user performs one decoding, a decoder output of the user i is:
$$p ( {b}_{i} [ t ] ) , t = 1 , … , k \qquad ( 36 )$$
the desired decoding result of the message sequence is obtained by the hard decision.

4. A lattice-based cell-free
MIMO system for performing the soft decision detection of the integer-combination as recited in claim 1, comprising:
a K user cell-free MIMO network model with a total of N_{BS} distributed units DU, wherein each DU is connected to a central unit CU via a backhaul link BH; a capacity of the BH link is constrained to be of a same order of magnitude as that of an air interface; each user is considered to have a single antenna, and the base station receiver has N antennas;
the lattice-based cell-free MIMO system further comprises: a channel-coding and modulation device, a cell-free network channel, an integer-combination soft decision detector, a decoder of channel-coding, and a user data decoder for CU;
a) the channel-coding and modulation device encodes each sequence of user message data
a 2^{m}-ary message data sequence of a user i is represented by a row vector bᵢ^{T}∈{0, 1, . . . , 2^{m}−1}, i=1, 2, . . . K; wherein k is a length of the message data sequence; message data of all K users is represented by a matrix B=[b₁, . . . , b_{K}]^{T} having a size of K×k; the message data sequence of each user is encoded using a 2^{m}-ary ring code: cᵢ=G⊗bᵢ, i=1, 2, . . . , K; then 2^{m}-PAM symbols are generated with the equation (1), and all users transmit in a same band at a same time;
b) the cell-free network channel receives signals from each distributed base station
a signal received by a receiver at a base station j is denoted as:
$${Y}_{j} = {\sum }_{1 j =}^{K} \sqrt{ρ} {h}_{j , i} {x}_{j}^{T} + {Z}_{j} = \sqrt{ρ} {H}_{j} X + {Z}_{j} , j = 1 , … , {N}_{B S} \qquad ( 37 )$$
the base station j is designed to generate Lⱼ integer-combinations about the K streams of message B=[b₁, . . . , b_{K}]^{T}, and Lⱼ is required to be as large as possible without exceeding a BH capacity limit; according to channel state information Hⱼ at the receiver, the base station selects Lⱼ linearly independent integer coefficient vectors a_{j,1}^{T}, . . . , a_{j,L}_{ⱼ}^{T}, and Aⱼ=[aⱼ, . . . , a_{j,K}]^{T} is the integer coefficient matrix chosen by the base station j;
c) the integer-combination soft decision detector calculates an a posteriori probability of an integer-combination of the K data streams encoded by channel-coding in a symbol-by-symbol form
the base station j uses integer-combination soft decision to compute the a posteriori probability of an l-th integer-combination symbol-by-symbol, so as to obtain the a posteriori probability of the integer-combination of the K data streams encoded by channel-coding:
$$p ( {a}_{j , l}^{T} ⊗ c [ t ] = θ \vert {y}_{j} [ t ] ) = \frac{1}{{2}^{m}} , θ = 0 , … , {2}^{m} - 1 , t = 1 , … , n \qquad ( 38 )$$
then the a posteriori probability is forwarded to the decoder of the 2^{m}-ary channel-coding;
d) the decoder of channel-coding decodes and outputs the a posteriori probability
decoder output:
$$p ( {a}_{j , l}^{T} ⊗ b [ t ] = θ ) θ = 0 , … , {2}^{m} - 1 , t = 1 , … , k \qquad ( 39 )$$
decision:
$${u}_{j , l} [ t ] = arg {max}_{θ} p ( {a}_{j , l}^{T} ⊗ b [ t ] = θ ) \qquad ( 40 )$$
if the decision is correct, the l-th integer-combination u_{j,l}^{T}=[u_{j,l}[1], . . . , u_{j,l}[k]] is obtained;
e) the user data decoder for CU generates a decision for message integer-combinations
the soft decision detection and decoding operations of Lⱼ integer-combination of the base station j are carried out in parallel to obtain Uⱼ=[u_{j,1}, . . . , u_{j,L}_{ⱼ}]^{T}=Aⱼ⊗B, which is then forwarded to the CU through the BH;
meanwhile, the soft decision and decoding operations of other base stations generate U₁, . . . , U_{N}_{_{BS}}; the CU collects all the integer-combinations;
$$U = {[ {U}_{1}^{T} , … , {U}_{{N}_{B S}}^{T} ]}^{T} = {A}_{C U} ⊗ B \qquad ( 41 )$$
if A_{CU}=[A₁^{T}, . . . , A_{N}_{_{BS}}^{T}]^{T} is full-ranked on Z₂_{^{m}}, there exists a unique inverse matrix A_{CU}⁻¹: A_{CU}⁻¹⊗A_{CU}=I, and the CU uses:
$${A}_{C U}^{- 1} ⊗ U = B \qquad ( 42 )$$
to recover all user message data B.

5. The lattice-based cell-free MIMO system, as recited in claim 4, wherein a total backhaul link BH usage of the system is
$$\frac{k m}{n} {\sum }_{j = 1}^{{N}_{B S}} {L}_{j}$$
bits/symbol, which is of the same order of magnitude as the capacity of the air interface.
